(19) United States
(12) Patent Application Publication
(10) Pub. No.: US 2015/0357637 A1
(43) Pub. Date: Dec. 10, 2015

(54) COMPOSITE MATERIAL FOR ELECTRODES, METHOD FOR PRODUCING SAME, AND SECONDARY BATTERY

(71) Applicant: SONY CORPORATION, Tokyo (JP)

(72) Inventors: Shun YAMANOI, Kanagawa (JP); Seiichiro TABATA, Kanagawa (JP); Hironori IIDA, Kanagawa (JP); Shinichiro YAMADA, Kanagawa (JP)

(73) Assignee: SONY CORPORATION, TOKYO (JP)

(21) Appl. No.: 14/760,614

(22) PCT Filed: Jan. 6, 2014
(86) PCT No.: PCT/JP2014/050035

§ 371 Date: Jul. 13, 2015

(30) Foreign Application Priority Data
Jan. 18, 2013 (JP) 2013-007439
Feb. 12, 2013 (JP) 2013-249512

(51) Int. Cl. H01M 4/36; H01M 10/0525

(52) U.S. Cl. CPC H01M 4/366; H01M 10/0525

(57) ABSTRACT

The present invention relates to a composite material for electrodes, which contains a plant-derived porous carbon material having a pore volume according to an MP method of 0.1 cm³/gram or more, or a volume of pores measuring less than 100 nm according to a BJH method of 0.3 cm³/gram or more; and lithium sulfide supported on the pores present in the porous carbon material, and in which the pore volume according to the MP method is less than 0.1 cm³/gram, or the volume of pores measuring less than 100 nm according to the BJH method is less than 0.3 cm³/gram.

### TECHNICAL FIELD

The present disclosure relates to a composite material for electrodes, a method for producing the same, and a secondary battery.

### BACKGROUND ART

As a result of an enhancement in the performance of portable electronic equipment, hybrid cars and the like of recent years, there is an ever increasing demand for higher capacity in the secondary batteries used therein. In regard to the currently used lithium ion secondary batteries, the progress in capacity increase has been slow for positive electrodes compared with negative electrodes, and even the capacities of lithium nickelate-based materials, which are considered to have relatively higher capacities, are about from 190 mAh/gram to 220 mAh/gram. On the other hand, sulfur has a theoretical capacity density as high as about 1670 mAh/gram, and sulfur is one of promising candidates for high capacity electrode materials. However, since simple substance sulfur has low electron conductivity and does not contain lithium (Li), lithium or an alloy containing lithium must be used in the negative electrode, and there is a problem that the range of selection for the negative electrode is narrow. In this regard, since lithium sulfide contains lithium, if lithium sulfide can be supported on the positive electrode, graphite or an alloy of silicon and the like can be used in the negative electrode. Then, the range of selection for the negative electrode material is dramatically widened, and it becomes possible to avoid problems such as the occurrence of short circuits caused by dendrite generation upon the use of lithium metal.

However, since lithium sulfide also has low electron conductivity, it is known that when lithium sulfide is simply mixed with a conductive material, for example, a carbon powder, charge and discharge do not occur in most cases. Thus, a technology for imparting electron conductivity to lithium sulfide is indispensable.

A lithium battery including a positive electrode which uses sulfur or lithium polysulfide as an active material, and a lithium ion conductive solid electrolyte layer, is well known from JP 6-275313 A. In regard to the technology disclosed in this patent application publication, a positive electrode material for a lithium battery is produced by the following method (see paragraph [0011] and paragraph [0018] of JP 6-275313 A). That is, first, sulfur or lithium polysulfide is dissolved in carbon disulfide, acetylene black is immersed in this solution, and this mixed liquid is filtered and dried under reduced pressure at room temperature. Thereby, a positive electrode material in which sulfur or lithium polysulfide is supported on acetylene black is obtained.

Furthermore, WO 2012/102037 A1 discloses an invention of a composite material containing a conductive agent and an alkali metal sulfide integrated with the surface of the conductive agent, and this composite material is used in the electrodes of lithium ion batteries. Here, disclosed as specific examples of the conductive agent are Ketjen black and acetylene black, and the average diameter of pores of the conductive agent determined based on a BJH method is from 0.1 nm to 40 nm.

### CITATION LIST

### Patent Document

Patent Document 1: JP 6-275313 A
Patent Document 2: WO 2012/102037 A1
Patent Document 3: JP 2010-163356 A

### SUMMARY OF THE INVENTION

### Problems to be Solved by the Invention

However, when production of a positive electrode containing lithium sulfide (Li₂S) as an active material is attempted, lithium sulfide (Li₂S) is not soluble in organic solvents, and when brought into contact with water, lithium sulfide is decomposed into LiOH. Therefore, it is extremely difficult to produce a positive electrode for lithium ion secondary batteries containing lithium sulfide (Li₂S) by the method described in JP 6-275313 A. On the other hand, the method for producing lithium sulfide is well known from JP 2010-163356 A. Here, according to JP 2010-163356 A, lithium sulfide thus produced is used as a raw material for the production of a solid electrolyte; however, nothing is mentioned therein on the use of lithium sulfide as a constituent material for a positive electrode. Furthermore, it is difficult to say that the characteristics of lithium ion batteries in the case of using Ketjen black or acetylene black as a conductive agent are satisfactory.

Therefore, an object of the present invention is to provide a composite material for electrodes which contains lithium sulfide as an active material and has excellent characteristics, a method for producing the composite material, and a secondary battery including an electrode constructed from the relevant composite material for electrodes.

### Solutions to Problems

A composite material for electrodes according to a first aspect of the present disclosure to achieve the above-described object contains:

a plant-derived porous carbon material having a pore volume according to an MP method, MP_{PC}, of 0.1 cm³/gram or more, preferably 0.15 cm³/gram or more, and more preferably 0.20 cm³/gram or more; and

lithium sulfide supported on the pores present in the porous carbon material.

The pore volume according to the MP method of the composite material for electrodes, MP₀, is less than 0.1 cm³/gram, preferably 0.08 cm³/gram or less, and more preferably 0.05 cm³/gram or less.

A composite material for electrodes related to a second aspect of the present disclosure to achieve the above-described object contains:

a plant-derived porous carbon material; and

lithium sulfide supported on the pores present in the porous carbon material.

The pore volume according to the MP method of the composite material for electrodes, MP₀, is less than 0.1 cm³/gram, preferably 0.08 cm³/gram or less, and more preferably 0.05 cm³/gram or less, and the pore volume according to the MP method after water washing of the composite material for electrodes, MP₁, is larger than the pore volume MP₀.

A composite material for electrodes related to a third aspect of the present disclosure to achieve the above-described object contains:

a plant-derived porous carbon material having a volume of pores measuring less than 100 nm according to a BJH method, BJH_{PC}, of 0.3 cm³/gram or more, preferably 0.4 cm³/gram or more, and more preferably 0.5 cm³/gram or more; and

lithium sulfide supported on the pores present in the porous carbon material.

The volume of pores measuring less than 100 nm according to the BJH method of the composite material for electrodes, BJH₀, is less than 0.3 cm³/gram, preferably 0.27 cm³/gram or less, and more preferably 0.25 cm³/gram or less.

A composite material for electrodes related to a fourth aspect of the present disclosure to achieve the above-described object contains:

a plant-derived porous carbon material; and

lithium sulfide supported on the pores present in the porous carbon material.

The volume of pores measuring less than 100 nm according to the BJH method of the composite material for electrodes, BJH₀, is less than 0.3 cm³/gram, preferably 0.27 cm³/gram or less, and more preferably 0.25 cm³/gram or less, and the volume of pores measuring 100 nm according to the BJH method after water washing of the composite material for electrodes, BJH_{1f} is larger than the pore volume BJH₀.

A composite material for electrodes related to a fifth aspect of the present disclosure to achieve the above-described object includes:

a porous carbon material having an inverse opal structure and

lithium sulfide supported on the pores present in the porous carbon material,

wherein the volume of pores measuring less than 100 nm according to a BJH method of the composite material for electrodes, BJH₀, is 20% or less of the volume of pores measuring less than 100 nm according to the BJH method of the porous carbon material, BJH_{PC}.

A composite material for electrodes related to a sixth aspect of the present disclosure to achieve the above-described object contains:

a porous carbon material; and

lithium sulfide supported on the pores present in the porous carbon material, and

the average particle size of the porous carbon material is 0.1 μm or more, preferably 0.5 μm or more, more preferably 1.0 μm or more, and is 75 μm or less, preferably 50 μm or less, and more preferably 35 μm or less.

A composite material for electrodes related to a seventh aspect of the present disclosure to achieve the above-described object includes:

a porous carbon material; and

lithium sulfide supported on the pores present in the porous carbon material,

wherein the proportion of the volume of pores measuring 100 nm or more according to a BJH method, BJH₁₀₀, is 30% or less.

A secondary battery related to a first aspect of the present disclosure to achieve the above-described object includes an electrode produced from the composite material for electrodes related to the first aspect of the present disclosure as described above. Furthermore, a secondary battery related to a second aspect of the present disclosure to achieve the above-described object includes an electrode produced from the composite material for electrodes related to the second aspect of the present disclosure as described above. A secondary battery related to a third aspect of the present disclosure to achieve the above-described object includes an electrode produced from the composite material for electrodes related to the third aspect of the present disclosure as described above. A secondary battery related to a fourth aspect of the present disclosure to achieve the above-described object includes an electrode produced from the composite material for electrodes related to the fourth aspect of the present disclosure as described above. A secondary battery related to a fifth aspect of the present disclosure to achieve the above-described object includes an electrode produced from the composite material for electrodes related to the fifth aspect of the present disclosure as described above. A secondary battery related to a sixth aspect of the present disclosure to achieve the above-described object includes an electrode produced from the composite material for electrodes related to the sixth aspect of the present disclosure as described above. A secondary battery related to a seventh aspect of the present disclosure to achieve the above-described object includes an electrode produced from the composite material for electrodes related to the seventh aspect of the present disclosure as described above.

A method for producing a composite material for electrodes related to a first aspect of the present disclosure to achieve the object described above is a method for producing a composite material for electrodes by producing lithium hydrosulfide in a solvent, subsequently adding thereto a plant-derived porous carbon material having a pore volume according to the MP method, MPₚ, of 0.1 cm³/gram or more, preferably 0.15 cm³/gram or more, and more preferably 0.20 cm³/gram or more, heating the mixture, and thereby obtaining a composite material for electrodes containing a porous carbon material and lithium sulfide supported on the pores present in the porous carbon material, in which

the pore volume according to the MP method of the composite material for electrodes, MP₀, is less than 0.1 cm³/gram, preferably 0.08 cm³/gram or less, and more preferably 0.05 cm³/gram or less.

A method for producing a composite material for electrodes related to a second aspect of the present disclosure to achieve the above-described object is a method for producing a composite material for electrodes by producing lithium hydrosulfide in a solvent, subsequently adding a plant-derived porous carbon material thereto, heating the mixture, and thereby obtaining a composite material for electrodes containing a porous carbon material and lithium sulfide supported on the pores present in the porous carbon material, in which

the pore volume according to the MP method of the composite material for electrodes, MP₀, is less than 0.1 cm³/gram, preferably 0.08 cm³/gram or less, and more preferably 0.05 cm³/gram or less, and the pore volume according to the MP method after water washing of the composite material for electrodes, MP₁, is larger than the pore volume MP₀.

A method for producing a composite material for electrodes related to a third aspect of the present disclosure to achieve the above-described object is a method for producing a composite material for electrodes by producing lithium hydrosulfide in a solvent, subsequently adding thereto a plant-derived porous carbon material having a volume of pores measuring less than 100 nm according to the BJH method, BJH_{PC}, of 0.3 cm³/gram or more, preferably 0.4 cm³/gram or more, and more preferably 0.5 cm³/gram or more, heating the mixture, and thereby obtaining a composite material for electrodes containing a porous carbon material and lithium sulfide supported on the pores present in the porous carbon material, in which

the volume of pores measuring less than 100 nm according to the BJH method of the composite material for electrodes, BJH₀, is less than 0.3 cm³/gram, preferably 0.27 cm³/gram or less, and more preferably 0.25 cm³/gram or less.

A method for producing a composite material for electrodes related to a fourth aspect of the present disclosure to achieve the above-described object is a method for producing a composite material for electrodes by producing lithium hydrosulfide in a solvent, subsequently adding a plant-derived porous carbon material thereto, heating the mixture, and thereby obtaining a composite material for electrodes containing a porous carbon material and lithium sulfide supported on the pores present in the porous carbon material, in which

the volume of pores measuring less than 100 nm according to the BJH method of the composite material for electrodes, BJH₀, is less than 0.3 cm³/gram, preferably 0.27 cm³/gram or less, and more preferably 0.25 cm³/gram or less, and

the volume of pores measuring less than 100 nm according to the BJH method after water washing of the composite material for electrodes, BJH₁, is larger than the pore volume BJH₀.

A method for producing a composite material for electrodes related to a fifth aspect of the present disclosure to achieve the above-described object is a method for producing a composite material for electrodes by producing lithium hydrosulfide in a solvent, subsequently adding a porous carbon material having an inverse opal structure thereto, heating the mixture, and thereby obtaining a composite material for electrodes containing a porous carbon material and lithium sulfide supported on the pores present in the porous carbon material, in which

the volume of pores measuring less than 100 nm according to the BJH method of the composite material for electrodes, BJH₀, is 20% or less of the volume of pores measuring less than 100 nm according to the BJH method of the porous carbon material, BJH_{PC}.

A method for producing a composite material for electrodes related to a sixth aspect of the present disclosure to achieve the above-described object is a method for producing a composite material for electrodes by producing lithium hydrosulfide in a solvent, adding a porous carbon material thereto, heating the mixture, and thereby obtaining a composite material for electrodes containing a porous carbon material and lithium sulfide supported on the pores present in the porous carbon material, in which

the average particle size of the porous carbon material is 0.1 μm or more, preferably 0.5 μm or more, more preferably 1.0 μm or more, and is 75 μm or less, preferably 50 μm or less, and more preferably 35 μm or less.

A method for producing a composite material for electrodes related to a seventh aspect of the present disclosure to achieve the above-described object is a method for producing a composite material for electrodes by producing lithium hydrosulfide in a solvent, subsequently adding a porous carbon material thereto, heating the mixture, and thereby obtaining a composite material for electrodes containing a porous carbon material and lithium sulfide supported on the pores present in the porous carbon material, in which

the proportion of the volume of pores measuring 100 nm or more according to the BJH method of the composite material for electrodes, BJH₁₀₀, is 30% or less.

### Effects of the Invention

In regard to the composite materials for electrodes, the secondary batteries, and the methods for producing a composite material for electrodes related to the first to fifth aspects and the seventh aspect of the present disclosure, since the pore volumes based on the MP method or the BJH method of the composite material for electrodes, or the pore volumes of the porous carbon material as a constituent material of the composite material and of the composite material for electrodes, are defined; and in regard to the composite material for electrodes, the secondary battery, and the method for producing a composite material for electrodes related to the sixth aspect of the present disclosure, the porous carbon material is defined and the average particle size is defined, high electron conductivity can be imparted to lithium sulfide by the porous carbon material, which is a conductive material. Thus, composite materials for electrodes containing lithium sulfide as an active material, intended for obtaining secondary batteries having excellent charge-discharge cycle characteristics, can be provided. Furthermore, in regard to the methods for producing a composite material for electrodes related to the first to seventh aspects of the present disclosure, a composite material for electrodes having lithium sulfide supported on the pores present in a porous carbon material can be obtained by producing lithium hydrosulfide in a solvent, subsequently adding a predetermined porous carbon material, and heating the mixture. Therefore, a desired composite material for electrodes having excellent characteristics can be reliably produced.

### BRIEF DESCRIPTION OF DRAWINGS

FIGS. 1A and 1B are a graph of the pore distribution according to the MP method and a graph of the pore distribution according to the BJH method, of the composite materials for electrodes and the plant-derived porous carbon materials of Example 1A-1, Example 1A-2, and Example 1A-3, respectively.

FIGS. 2A and 2B are a graph of the pore distribution according to the MP method and a graph of the pore distribution according to the BJH method, of the composite material for electrode of Comparative Example 1A and Ketjen black, respectively.

FIGS. 3A and 3B are graphs showing the results of an X-ray diffraction analysis (XRD) of the composite materials for electrodes of Comparative Example 1A and Example 1A-1, respectively.

FIGS. 4A and 4B are graphs showing the results of an X-ray diffraction analysis (XRD) of the composite materials for electrodes of Example 1A-2 and Example 1A-3, respectively.

FIG. 5 is a graph showing the results of a charge-discharge test of the lithium-sulfur secondary battery of Example 2.

FIG. 6 is a graph showing the results of a charge-discharge test of the lithium-sulfur secondary batteries of Comparative Example 2A and Comparative Example 2C.

FIG. 7 is a graph showing the results of a charge-discharge test of the lithium-sulfur secondary battery of Comparative Example 2B.

FIG. 8 is a graph showing the results of a charge-discharge test under different conditions of the lithium-sulfur secondary batteries of Example 2 and Comparative Example 2A.

FIG. 9 is a graph showing the results of a charge-discharge test of the lithium-sulfur secondary battery of Example 3.

FIG. 10 is a graph showing the results of a charge-discharge test of the lithium-sulfur secondary battery of Example 4.

FIG. 11 is a graph showing the results of a charge-discharge test of the lithium-sulfur secondary battery of Example 5.

FIG. 12 is a graph showing the results of a charge-discharge test of the lithium-sulfur secondary battery of Example 6.

### MODE FOR CARRYING OUT THE INVENTION

Hereinafter, the present disclosure is explained based on Examples, with reference to the drawings. However, the present disclosure is not intended to be limited to the Examples, and the various values and materials given in the Examples are only for illustrative purposes. The explanation is given in the following order.

1. Explanation on the general matters of the composite materials for electrodes, methods for producing the composite materials, and the secondary batteries related to the first to seventh aspects of the present disclosure

2. Example 1 (the composite materials for electrodes and the methods for producing the composite materials related to the first to seventh aspects of the present disclosure)

3. Example 2 (the secondary batteries related to the first to seventh aspects of the present disclosure)

4. Example 3 (variation of Example 2)

5. Example 4 (variation of Example 3)

6. Example 5 (another variation of Example 3)

7. Example 6 (still another variation of Example 3), and others

### Explanation on General Matters of Composite Materials for Electrodes, Methods for Production of Composite Materials, and Secondary Batteries Related to First to Seventh Aspects of Present Disclosure

In the following explanation, the composite materials for electrodes related to the first to seventh aspects of the present disclosure, the methods for producing a composite material for electrodes related to the first to seventh aspects of the present disclosure, and the secondary batteries related to the first to seventh aspects of the present disclosure may be collectively referred to simply as “present disclosure”. Furthermore, the composite material for electrodes related to the first aspect of the present disclosure, the method for producing a composite material for electrodes related to the first aspect of the present disclosure, and the secondary battery related to the first aspect of the present disclosure may be collectively referred to simply as “first aspect of the present disclosure”. The composite material for electrodes related to the second aspect of the present disclosure, the method for producing a composite material for electrodes related to the second aspect of the present disclosure, and the secondary battery related to the second aspect of the present disclosure may be collectively referred to simply as “second aspect of the present disclosure”. The composite material for electrodes related to the third aspect of the present disclosure, the method for producing a composite material for electrodes related to the third aspect of the present disclosure, and the secondary battery related to the third aspect of the present disclosure may be collectively referred to simply as “third aspect of the present disclosure”. The composite material for electrodes related to the fourth aspect of the present disclosure, the method for producing a composite material for electrodes related to the fourth aspect of the present disclosure, and the secondary battery related to the fourth aspect of the present disclosure may be collectively referred to simply as “fourth aspect of the present disclosure”. The composite material for electrodes related to the fifth aspect of the present disclosure, the method for producing a composite material for electrodes related to the fifth aspect of the present disclosure, and the secondary battery related to the fifth aspect of the present disclosure may be collectively referred to simply as “fifth aspect of the present disclosure”. The composite material for electrodes related to the sixth aspect of the present disclosure, the method for producing a composite material for electrodes related to the sixth aspect of the present disclosure, and the secondary battery related to the sixth aspect of the present disclosure may be collectively referred to simply as “sixth aspect of the present disclosure”. The composite material for electrodes related to the seventh aspect of the present disclosure, the method for producing a composite material for electrodes related to the seventh aspect of the present disclosure, and the secondary battery related to the seventh aspect of the present disclosure may be collectively referred to simply as “seventh aspect of the present disclosure”. Furthermore, the composite materials for electrodes related to the first to seventh aspects of the present disclosure may be collectively referred to simply as “composite material for electrodes of the present disclosure”; the secondary batteries related to the first to seventh aspects may be collectively referred to simply as “secondary batteries of the present disclosure”; and the methods for producing a composite material for electrodes related to the first to seventh aspects of the present disclosure may be collectively referred to simply as “method for producing a composite material for electrodes of the present disclosure”.

In the third aspect and the fourth aspect of the present disclosure, the proportion of the volume of pores measuring 100 nm or more according to the BJH method of the composite material for electrodes, BJH₁₀₀, may be 30% or less, and in the third aspect and the fourth aspect of the present disclosure including the relevant form, the pore volume according to the BJH method after water washing of the composite material for electrodes, BJH₁, may be larger than the value BJH₂ obtained by dividing the pore volume of the composite material for electrodes, BJH₀, by the percentage content of the porous carbon material. Furthermore, in the third aspect and the fourth aspect of the present disclosure including the preferred forms described above, the pore volume according to the MP method of the plant-derived porous carbon material, MP_{PC}, may be 0.1 cm³/gram or more, preferably 0.15 cm³/gram or more, and more preferably 0.20 cm³/gram or more, and the pore volume according to the MP method of the composite material for electrodes, MP₀, may be less than 0.1 cm³/gram, preferably 0.08 cm³/gram or less, and more preferably 0.05 cm³/gram or less, or in another form, the pore volume according to the MP method of the composite material for electrodes, MP₀, may be less than 0.1 cm³/gram, preferably 0.08 cm³/gram or less, and more preferably 0.05 cm³/gram or less, and the pore volume according to the MP method after water washing of the composite material for electrodes, MP₁, may be larger than the pore volume MP₀.

Furthermore, in the first to fourth aspects of the present disclosure including the various preferred forms explained above, the average particle size of the porous carbon material may be 0.1 μm or more, preferably 0.5 μm or more, and more preferably 1.0 μm or more, and may be 75 μm or less, preferably 50 μm or less, and more preferably 35 μm or less.

In the fifth aspect of the present disclosure, the proportion of the volume of pores measuring 100 nm or more according to the BJH method of the composite material for electrodes, BJH₁₀₀, may be 30% or less. Furthermore, in the fifth aspect of the present disclosure including the related forms, or in the seventh aspect of the present disclosure, the average particle size of the porous carbon material may be 0.1 μm or more, preferably 0.5 μm or more, and more preferably 1.0 μm or more, and may be preferably 75 μm or less, preferably 50 μm or less, and more preferably 35 μm or less.

In the fifth to seventh aspects of the present disclosure including the various preferred forms described above, the porous carbon material may use a plant-derived material as a raw material, and the pore volume according to the MP method, MP_{PC}, of the porous carbon material may be 0.1 cm³/gram or more, preferably 0.15 cm³/gram or more, and more preferably 0.20 cm³/gram or more, while the pore volume according to the MP method, MP₀, of the composite material for electrodes may be less than 0.1 cm³/gram, preferably 0.08 cm³/gram or less, and more preferably 0.05 cm³/gram or less.

Furthermore, in the fifth to seventh aspects of the present disclosure including the various preferred forms described above, the porous carbon material may use a plant-derived material as a raw material; the pore volume according to the MP method, MP₀, of the composite material for electrodes may be less than 0.1 cm³/gram, preferably 0.08 cm³/gram or less, and more preferably 0.05 cm³/gram or less; and the pore volume according to the MP method, MP₁, after water washing of the composite material for electrodes may be larger than the pore volume, MP₀.

In the fifth to seventh aspects of the present disclosure including the various preferred forms described above, the porous carbon material may use a plant-derived material as a raw material; the volume of pores measuring less than 100 nm according to the BJH method of the plant-derived porous carbon material, BJH_{PC}, may be 0.3 cm³/gram or more, preferably 0.4 cm³/gram or more, and more preferably 0.5 cm³/gram or more; and the volume of pores measuring less than 100 nm according to the BJH method of the composite material for electrodes, BJH₀, may be less than 0.3 cm³/gram, preferably 0.27 cm³/gram or less, and more preferably 0.25 cm³/gram or less. Alternatively, in another form, the porous carbon material may use a plant-derived material as a raw material; the volume of pores measuring less than 100 nm according to the BJH method of the composite material for electrodes, BJH₀, may be less than 0.3 cm³/gram, preferably 0.27 cm³/gram or less, and more preferably 0.25 cm³/gram or less; and the volume of pores measuring less than 100 nm according to the BJH method after water washing of the composite material for electrodes, BJH₁, may be larger than the pore volume BJH₀.

Furthermore, in the fifth to seventh aspects of the present disclosure including the various preferred forms described above, the proportion of the volume of pores measuring 100 nm or more according to the BJH method of the composite material for electrodes, BJH₁₀₀, may be 30% or less.

In the fifth to seventh aspects of the present disclosure including the various preferred forms described above, the pore volume according to the BJH method after water washing of the composite material for electrodes, BJH₁, may be larger than the value BJH₂ obtained by dividing the pore volume of the composite material for electrodes, BJH₀, by the percentage content of the porous carbon material.

Furthermore, in the method for producing a composite material for electrodes related to the first to seventh aspects of the present disclosure including these preferred forms, the plant-derived porous carbon material may use a plant-derived material having a percentage content of silicon of 5% by mass or more as a raw material. In this case, the method may be configured to obtain a porous carbon material by carbonizing the plant-derived material at 400° C. to 1400° C. and then treating the product with an acid or an alkali. Furthermore, the method may be configured to carry out, after the treatment with an acid or an alkali, a treatment of heating the resultant at a temperature exceeding the temperature used in the carbonization, and in this case, the method may also be configured to eliminate silicon components in the plant-derived material that has been carbonized, through a treatment with an acid or an alkali.

Furthermore, in the method for producing a composite material for electrodes of the present disclosure including the various preferred forms described above, the production of lithiumhydrosulfide in the solvent may be achieved by adding lithium hydroxide to the solvent and bubbling hydrogen sulfide gas into the solvent. Furthermore, it is preferable to set the temperature of heating after the addition of the porous carbon material, to 150° C. to 230° C.

In the first to seventh aspects of the present disclosure including the various preferred forms described above, the plant-derived porous carbon material may use a plant-derived material having a percentage content of silicon of 5% by mass or more as a raw material. Alternatively, in the fifth to seventh aspects of the present disclosure including the various preferred forms described above, the pores (voids) in the porous carbon material having an inverse opal structure may have three-dimensional regularity and may be arranged macroscopically in a disposition that constitutes a crystal structure. In this case, the pores (voids) may be arranged macroscopically in the (1,1,1) plane orientation of a face-centered cubic lattice on the material surface.

In the first to seventh aspects of the present disclosure including the various preferred forms described above, the full width at half maximum of the X-ray diffraction intensity peak of the {220} plane of lithium sulfide may be 0.37 degrees or less.

In the first to seventh aspects of the present disclosure including the various preferred forms described above, the value of the specific surface according to a nitrogen BET method of the porous carbon material may be 100 m²/gram or more.

In the secondary battery of the present disclosure including the various preferred forms described above, the electrode may constitute a positive electrode. The secondary battery of the present disclosure including the various preferred forms described above including such a form may be formed from a lithium-sulfur secondary battery.

According to a form, the negative electrode may contain at least one negative electrode active material selected from the group consisting of lithium, sodium, a lithium alloy, a sodium alloy, carbon, silicon, a silicon alloy, a silicon compound, aluminum, tin, antimony, magnesium, and a lithium/inactive sulfur composite. More specific examples include known negative electrode materials, including metallic materials such as lithium titanate, lithium metal, sodium metal, a lithium-aluminum alloy, a sodium-aluminum alloy, a lithium-tin alloy, a sodium-tin alloy, a lithium-silicon alloy, a sodium-silicon alloy, a lithium-antimony alloy, and a sodium-antimony alloy; and carbon materials such as crystalline carbon materials and non-crystalline carbon materials including natural graphite, artificial graphite, carbon black, acetylene black, graphite, activated carbon, carbon fibers, cokes, soft carbon, and hard carbon. Alternatively, examples of the element constituting the silicon alloy include tin, nickel, copper, iron, cobalt, manganese, zinc, indium, silver, titanium, germanium, bismuth, antimony, and chromium, and examples of the element that constitutes the silicon compound include oxygen and carbon. In some cases, two or more kinds of negative electrode active materials may be used in combination.

Examples of an electric current collector that constitutes the secondary battery include nickel, stainless steel, copper, and titanium. The current collector may be constructed from a foil, a sheet, a mesh, an expanded metal, or a punched metal, or the like. In some cases, a form in which the negative electrode is omitted, and the current collector functions as the negative electrode as well, may also be employed.

Examples of a separator that constitutes the secondary battery include a separator made of glass that absorbs and retains a liquid electrolyte, and a porous sheet or a nonwoven fabric formed from a polymer. Examples of the polymer that constitutes the porous sheet include a polyolefin such as polyethylene or polypropylene, a multilayer structure of a polyolefin, apolyimide, and aramid. Furthermore, regarding the nonwoven fabric, known materials such as cotton, rayon, acetate, Nylon (registered trademark), polyesters, polyolefins, polyimides, and aramid can be used singly or as mixtures.

Examples of the liquid electrolyte include, but are not limited to, a liquid electrolyte in which at least portions of a glyme and an alkali metal salt form a complex [specifically, for example, a mixture of tetraglyme and lithium bis(trifluoromethylsulfonyl)imide (LiTFSI, (CF₃SO₂)₂NLi) ([Li(G4)][TFSI])], and a liquid electrolyte containing a mixture of lithium nitrate (LiNO₃) and LiTFSI.

The glyme can be represented by the following formula. Here, R represents any one of an alkyl group having 1 to 9 carbon atoms which may be substituted with fluorine, a phenyl group which may be substituted with a halogen atom, and a cyclohexyl group which may be substituted with a halogen atom; x represents a number from 1 to 6. Examples of the alkyl group include a methyl group, an ethyl group, a propyl group, an isopropyl group, a butyl group, an isobutyl group, a pentyl group, an isopentyl group, a hexyl group, a heptyl group, an octyl group, and a nonyl group. Examples of the phenyl group which may be substituted with a halogen atom include a 2-chlorophenyl group, a 3-chlorophenyl group, a 4-chlorophenyl group, a 2,4-dichlorophenyl group, a 2-bromophenyl group, a 3-bromophenyl group, a 4-bromophenyl group, a 2,4-dibromophenyl group, a 2-iodophenyl group, a 3-iodophenyl group, a 4-iodophenyl group, and a 2,4-iodophenyl group. Examples of the cyclohexyl group which may be substituted with a halogen atom include a 2-chlorocyclohexyl group, a 3-chlorocyclohexyl group, a 4-chlorocyclohexyl group, a 2,4-dichlorocyclohexyl group, a 2-bromocyclohexyl group, a 3-bromocyclohexyl group, a 4-bromocyclohexyl group, a 2,4-dibromocyclohexyl group, a 2-iodocyclohexyl group, a 3-iodocyclohexyl group, a 4-iodocyclohexyl group, and a 2,4-diiodocyclohexyl group.

R—(OCH₂CH₂)ₓ—OR

Furthermore, when an alkali metal salt is represented by MX, M represents an alkali metal; and X represents Cl, Br, I, BF₄, PF₆, CF₃SO₃, ClO₄, CF₃CO₂, AsF₆, SbF₆, AlCl₄, N(CF₃SO₂)₂, N(CF₃CF₂SO₂)₂, PF₃(C₂F₅)₃, N(FSO₂)₂, N(FSO₂) (CF₃SO₂), N(CF₃CF₂SO₂)₂, N(C₂F₄S₂O₄), N(C₃F₆S₂O₄), N(CN)₂, N(CF₃SO₂), and (CF₃CO).

The average particle size of the porous carbon material (average particle size of the porous carbon material before compositization with lithium sulfide (raw material)) can be measured by a laser diffraction scattering method.

Specifically, the average particle size of the porous carbon material may be measured using a laser diffraction scattering type particle size distribution analyzer of LMS series manufactured by Seishin Enterprise Co., Ltd., or SALD series manufactured by Shimadzu Corp. Furthermore, the average particle size refers to the median diameter (also referred to as d50). That is, the average particle size refers to the diameter at which, when the porous carbon material is divided into two groups at a certain particle size, the amounts of the larger side and the smaller side are equal. Furthermore, in the case of measuring the particle size by a wet method, measurement may be carried out by adding a surfactant in order to obtain a satisfactory dispersed state, or oxidizing the surface of the porous carbon material with an oxidizing agent. Furthermore, the dispersed state may be made satisfactory in advance by performing ultrasonic cleaning or using a homogenizer.

The average particle size of the porous carbon material that constitutes an electrode, that is, the porous carbon material that is in a state of having been made into an electrode, can be obtained by making an observation using scanning electron microscopy (SEM). Alternatively, the average particle size of the porous carbon material itself can be measured by the following method using a sample obtained by stripping off the porous carbon material from the electrode. That is, a sample is introduced into N-methyl-2-pyrrolidone (NMP), the sample is stirred for 3 hours at 200° C., and then the sample is dried for 48 hours at 300° C. in a nitrogen atmosphere. Subsequently, 1 gram of the sample is added to 300 milliliters of water, and the mixture is sufficiently stirred at 24° C. while ultrasonic waves are applied thereto. Furthermore, this operation is carried out several times as necessary. Thereafter, an operation of performing centrifugation, removing the liquid phase, adding water, and performing ultrasonic cleaning is carried out two times, and then the particle size is measured based on the method for measuring the average particle size described above.

Furthermore, regarding the method for water washing the composite material for electrodes according to the second aspect and the fourth aspect of the present disclosure, for example, the following method may be employed. That is, 1 gram of a composite material for electrodes and 300 milliliters of water are introduced into a beaker, and ultrasonic cleaning is carried out for 1 hour. Subsequently, centrifugation is carried out, and a supernatant is discarded. This operation is repeated two times in total, and then a solid component thus obtained is dried in air for 12 hours at 120° C.

The composite material for electrodes of the present disclosure means a composite material containing a porous carbon material and lithium sulfide supported on the pores of the porous carbon material, the material being in a powder form or a bulk form that does not contain a binder or a current collector.

An analysis of various elements in the porous carbon material can be carried out by, for example, an energy dispersive spectroscopy method (EDS) using an energy dispersive type X-ray spectroscopic analysis (for example, JED-2200F manufactured by JEOL, Ltd). Here, the measurement conditions may be set to, for example, a scan voltage of 15 kV and an illumination current of 10 μA.

A plant-derived porous carbon material can be obtained by, as described above, carbonizing a plant-derived material at 400° C. to 1400° C., and then treating the material with an acid or an alkali. Meanwhile, the method for producing such a plant-derived porous carbon material is called a “method for producing a plant-derived porous carbon material”. Also, a material that has been obtained by carbonizing a plant-derived material at 400° C. to 1400° C. but has not been treated with an acid or an alkali, is called a “porous carbon material precursor” or a “carbonaceous material”.

The percentage content of silicon (Si) of the porous carbon material obtained by carbonizing and then treating with an acid or an alkali is preferably less than 5% by mass, more preferably 3% by mass or less, and even more preferably 1% by mass or less. Meanwhile, the percentage content of silicon (Si) in the raw material (plant-derived material before carbonization) is preferably 5% by mass or more, as described above.

In regard to the method for producing a plant-derived porous carbon material, a step of applying an activation treatment after the treatment with an acid or an alkali may be included, and after an activation treatment is applied, a treatment with an acid or an alkali may be carried out. Furthermore, in the method for producing a plant-derived porous carbon material including such a preferred form, the process may depend on the plant-derived material used; however, before the plant-derived material is carbonized, the plant-derived material may be subjected to a heat treatment in a state of having oxygen blocked, at a temperature lower than the temperature used for the carbonization (for example, 400° C. to 700° C.) Meanwhile, such a heat treatment is called a “pre-carbonization treatment”. Thereby, the tar component that will be produced in the course of carbonization can be extracted, and as a result, the tar component that will be produced in the course of carbonization can be reduced or eliminated. Meanwhile, a state in which oxygen is blocked can be achieved by, for example, achieving an inert gas atmosphere of nitrogen gas or argon gas, by achieving a vacuum atmosphere, or bringing the plant-derived material into a kind of smothered state. Furthermore, in the method for producing a plant-derived porous carbon material, although the process may depend on the plant-derived material used, the plant-derived material may be immersed in an alcohol (for example, methyl alcohol, ethyl alcohol, or isopropyl alcohol) in order to reduce the mineral component or moisture included in the plant-derived material, and in order to prevent generation of foul odor in the course of carbonization. In the method for producing a plant-derived porous carbon material, a pre-carbonization treatment may be carried out thereafter. An example of a material for which it is preferable to apply a pre-carbonization treatment in an inert gas atmosphere, include plants that generate large amounts of pyroligneous acids (tar or light oil fraction). Furthermore, examples of a material for which it is preferable to apply a pretreatment with an alcohol include marine algae containing large amounts of iodine and various minerals.

In the method for producing a plant-derived porous carbon material, the plant-derived material is carbonized at 400° C. to 1400° C., and here, carbonization generally means that an organic substance (in the present disclosure, the raw material for producing the plant-derived material or the porous carbon material having an inverse opal structure) is heat treated and is thereby converted to a carbonaceous material (see, for example, JIS M0104-1984). Meanwhile, the atmosphere for the carbonization may be an atmosphere in which oxygen is blocked, and specific examples include a vacuum atmosphere, an inert gas atmosphere of nitrogen gas or argon gas, and an atmosphere that brings a raw material for producing a plant-derived material or a porous carbon material having an inverse opal structure into a kind of smothered state. The rate of temperature increase to reach the carbonization temperature is not intended to be limited; however, the rate of temperature in the relevant atmosphere may be 1° C./min or more, preferably 3° C./min or more, and more preferably 5° C./min or more. Furthermore, the upper limit of the carbonization time may be 10 hours, preferably 7 hours, and more preferably 5 hours; however, the carbonization time is not intended to be limited to this. The lower limit of the carbonization time may be set to a time period in which a plant-derived material is reliably carbonized. Furthermore, the plant-derived material may be pulverized as desired to obtain a desirable particle size, or may be classified. The plant-derived material may also be washed in advance. Alternatively, a porous carbon material intermediate or a porous carbon material obtained after an activation treatment may be pulverized as described to obtain a desirable particle size, or may be classified. There are no particular limitations on the type, configuration and structure of the furnace used for the carbonization, and a continuous furnace can be used, while a batch furnace can also be used.

In regard to the method for producing a plant-derived porous carbon material, a treatment of heating at a temperature exceeding the temperature used for the carbonization may also be carried out after the treatment with an acid or an alkali. As such, when a treatment of heating at a temperature exceeding the temperature used for the carbonization is carried out, the porous carbon material undergoes a kind of sintering, and as a result, a porous carbon material having more suitable voids (size and volume) for a composite material for electrodes can be provided. An example of the atmosphere for the heating treatment may be an atmosphere in which oxygen is blocked, and specific examples thereof include a vacuum atmosphere, an inert gas atmosphere of nitrogen gas or an argon gas, and an atmosphere that brings the porous carbon material intermediate into a kind of smothered state. The rate of temperature increase to reach the temperature of the heating treatment is not limited; however, the rate of temperature increase in the relevant atmosphere may be 1° C./min or more, preferably 3° C./min or more, and more preferably 5° C./min or more. The difference between the temperature for the carbonization and the temperature for the heating treatment may be appropriately determined by performing various tests. Also, the upper limit of the heating treatment time may be 10 hours, preferably 7 hours, and more preferably 5 hours; however, the heating treatment time is not limited to this. The lower limit of the heating treatment time may be any time in which desired characteristics can be imparted to the porous carbon material. There are no particular limitations on the type, configuration and structure of the furnace used for the heating treatment, and a continuous furnace can be used, while a batch furnace can also be used.

In regard to the method for producing a plant-derived porous carbon material, when an activation treatment is applied as described above, micropores having a pore diameter of less than 2 nm (will be described below) can be increased. Examples of the method for the activation treatment include a gas activation method and a chemical activation method. Here, the gas activation method is a method for developing a microstructure using the volatile components and carbon molecules in a porous carbon material intermediate or a porous carbon material, by using oxygen, steam, carbon dioxide gas, air or the like as an activating agent, and heating a porous carbon material intermediate or a porous carbon material in the relevant gas atmosphere at 700° C. to 1400° C., preferably 700° C. to 1000° C., and more preferably 800° C. to 1000° C., for several tens of minutes to several hours. Meanwhile, the heating temperature for the activation treatment may be appropriately selected based on the kind of the plant-derived material, the kind or the concentration of the gas, and the like. The chemical activation method is a method of performing activation using zinc chloride, iron chloride, calcium phosphate, calcium hydroxide, magnesium carbonate, potassium carbonate, sulfuric acid or the like instead of the oxygen or steam used in the gas activation method, washing the material with hydrochloric acid, adjusting the pH with an alkaline aqueous solution, and drying the material.

In the method for producing a plant-derived porous carbon material, as described above, it is preferable to eliminate silicon components in the plant-derived material after carbonization, by means of a treatment with an acid or an alkali. Here, examples of the silicon components include silicon components such as silicon dioxide, silicon oxide, and silicates. As such, when the silicon components in the plant-derived material after carbonization are eliminated, a porous carbon material having a high specific surface area can be obtained. In some cases, silicon components in the plant-derived material after carbonization may also be eliminated based on a dry etching method. That is, according to a preferred form of the porous carbon material, a plant-derived material containing silicon (Si) is used as a raw material; however, on the occasion of converting the plant-derived material to a porous carbon material precursor or a carbonaceous material, when the plant-derived material is carbonized at a high temperature (for example, 400° C. to 1400° C.), the silicon contained in the plant-derived material is converted not to silicon carbide (SiC), but to silicon components (silicon oxides) such as silicon dioxide (SiOₓ), silicon oxide, and silicates. Furthermore, the silicon components (silicon oxides) contained in the plant-derived material before carbonization do not undergo any substantial change even if carbonization is carried out at a high temperature (for example, 400° C. to 1400° C.) Therefore, as the plant-derived material is treated with an acid or an alkali (base) in the subsequent step, the silicon components (silicon oxides) such as silicon dioxide, silicon oxide and silicates are eliminated, and as a result, a large value of specific surface area according to the nitrogen BET method can be obtained. Furthermore, the porous carbon material is an environment-friendly material derived from a natural product, and its microstructure is obtained by treating the silicon components (silicon oxides) previously contained in the plant-derived material as a raw material, with an acid or an alkali, and removing the silicon components. Therefore, the arrangement of pores maintains the biological regularity exhibited by plants.

As described above, for the porous carbon material, a plant-derived material can be used as a raw material. Here, examples of plant-derived material include chaffs and straws of rice (paddy), barley, wheat, rye, Japanese millet, foxtail millet and the like; coffee beans, tea leaves (for examples, leaves of green tea and black tea), sugarcane (more specifically, strained lees of sugarcane), corn (more specifically, cores of corn), peels of fruits (for example, peels of citrus fruits such as orange peel, grapefruit peel, and tangerine peel, and banana peel), reed, and wakame seaweed stems; however, the examples are not limited to these. Other examples include vascular plants that grow on the land, ferns, bryophytes, algae, and seaweeds. Meanwhile, these materials may be used singly as raw materials, or plural kinds thereof may be used in mixture. Furthermore, there are no particular limitations on the shape or form of the plant-derived material, and for example, chaffs or straws themselves may be used, or drying processed products may also be used. Moreover, products that have been subjected to various treatments such as a fermentation treatment, a roasting treatment, and an extraction treatment in connection with food and drink processing of beer, Western liquors, and the like, can also be used. Particularly, from the viewpoint of promoting recycling of industrial wastes, it is preferable to use straws and chaffs after processing such as threshing. These straws and chaffs after processing are easily available in large amounts from, for example, agricultural cooperatives, brewing companies, food companies, and food processing companies.

A porous carbon material has many pores. The pores include “mesopores” having a pore diameter of 2 nm to 50 nm; “micropores” having a pore diameter of less than 2 nm; and “macropores” having a pore diameter of more than 50 nm. Specifically, the mesopores include, for examples, a large proportion of pores having a pore diameter of 20 nm or less, and particularly a large proportion of pores having a diameter of 10 nm or less. Furthermore, in regard to the micropores having a diameter of 2 nm or less, superior performance is exhibited as the pore volume is larger.

A nitrogen BET method is a method in which an adsorption isotherm is measured by allowing an adsorbent (here, the porous carbon material) to adsorb and desorb nitrogen that serves as an adsorbate molecule, and the measured data are analyzed on the basis of the BET equation represented by formula (1), and the specific surface area, the pore volume, and the like can be calculated based on this method. Specifically, in a case where the value of the specific surface area is calculated by the nitrogen BET method, first, an adsorption isotherm is determined by allowing the porous carbon material to adsorb and desorb nitrogen that serves as an adsorbate molecule. Then, from the adsorption isotherm thus obtained, [p/{Vₐ(p₀−p)}] is calculated based on formula (1), or based on formula (1′) modified from formula (1), and is plotted against the equilibrium relative pressure (p/p₀). This plot is assumed to be a straight line, and the slope s (=[(C−1)/(C·Vₘ)]) and the intercept i (=[1/(C·V)]) are calculated based on the least square method. Then, Vₘ and C are calculated from the slope s and the intercept i thus determined, based on formula (2-1) and formula (2-2). In addition, the specific surface area a_{SBET} is calculated from Vₘ based on formula (3) (see the manual for BELSORP-mini and BELSORP analysis software manufactured by BEL Japan, Inc., page 62 to page 66). This nitrogen BET method is an analytic method in conformity with JIS R 1626-1996 “Method for measuring specific surface area of fine ceramic powders by gas adsorption BET method”.

Vₐ=(Vₘ·C·p)/[(p₀−p){1+(C−1)(p/p₀)}] (1)

[p/{Vₐ(p₀−p)}]=[(C−1)/(C·Vₘ)](p/p₀)+[1/(C·Vₘ)] (1′)

Vₘ=1/(s+i) (2-1)

C=(s/i)+1 (2-2)

a_{sBET}=(Vₘ·L·σ)/22414 (3)

provided that:

Vₐ: amount of adsorption

Vₘ: amount of adsorption of monomolecular layer

p: pressure at equilibrium of nitrogen

p₀: saturated vapor pressure of nitrogen

L: Avogadro's number

σ: adsorption cross-sectional area of nitrogen

In the case of calculating the pore volume Vₚ by the nitrogen BET method, for example, the adsorption data of the adsorption isotherm thus determined is subjected to linear interpolation, and the amount of adsorption V at a relative pressure set as the pore volume calculation relative pressure is determined. The pore volume Vₚ can be calculated from this amount of adsorption V based on formula (4) (see the manual for BELSORP-mini and BELSORP analysis software manufactured by BEL Japan, Inc., page 62 to page 65). Meanwhile, the pore volume based on the nitrogen BET method may be simply referred to as “pore volume” in the following descriptions.

Vₚ=(V/22414)×(M_{g}/ρ_{g}) (4)

provided that:

V: amount of adsorption at the relative pressure

M_{g}: molecular weight of nitrogen

ρ_{g}: density of nitrogen

The pore diameter of mesopores can be calculated, for example, as a distribution of pores from the rate of change in pore volume with respect to the pore diameter based on a BJH method. The BJH method is a method that is widely used as a pore distribution analysis method. In a case where a pore distribution analysis is carried out based on the BJH method, first, a desorption isotherm is determined by allowing the porous carbon material to adsorb and desorb nitrogen that serves as an adsorbate molecule. Then, the thickness of the adsorption layer when the adsorbate molecules are desorbed stepwise from the state in which pores are filled with the adsorbate molecules (for example, nitrogen), and the inner diameter (twice the core radius) of holes generated at that time are determined based on the desorption isotherm thus determined, and the pore radius rₚ is calculated on the basis of formula (5), while the pore volume is calculated on the basis of formula (6). Then, the rate of change in pore volume (dVₚ/drₚ) with respect to the pore diameter (2rₚ) is plotted against the pore radius and the pore volume, and thereby a pore distribution curve is obtained (see the manual for BELSORP-mini and BELSORP analysis software manufactured by BEL Japan, Inc., page 85 to page 88).

rₚ=t+rₖ (5)

Vₚₙ=Rₙ·dVₙ−Rₙ·dtₙ·c·ΣAₚⱼ (6)

provided that:

Rₙ=rₚₙ²/(rₖₙ−1+dtₙ)² (7)

Here,

rₚ: pore radius

rₖ: core radius (inner radius/2) in the case where an adsorption layer having a thickness t is adsorbed to the inner walls of a pre having a pore radius rₚ at that pressure

Vₚₙ: pore volume when the n-th desorption of nitrogen has occurred

dVₙ: amount of change at that time

dtₙ: amount of change in thickness tₙ of the adsorption layer when the n-th desorption of nitrogen has occurred

rₖₙ: core radius at that time

c: constant value

rₚₙ: pore radius when the n-th desorption of nitrogen has occurred.

Furthermore, ΣAₚⱼ represents an integrated value of the area of the wall surface of the pores from j=1 to j=n−1.

The pore diameter of micropores can be calculated, for example, as a distribution of pores from the rate of change in pore volume with respect to the pore diameter based on the MP method. Ina case where a pore distribution analysis carried out by the MP method, first, an adsorption isotherm is determined by allowing the porous carbon material to adsorb nitrogen. Then, this adsorption isotherm is converted to the pore volume with respect to the thickness t of the adsorption layer (plotted against t). Then, a pore distribution curve can be obtained based on the curvature of this plot (amount of change in pore volume with respect to the amount of change in thickness t of the adsorption layer) (see the manual for BELSORP-mini and BELSORP analysis software manufactured by BEL Japan, Inc., page 72 to page 73 and page 82).

The porous carbon material precursor is treated with an acid or an alkali, and specific examples of the treatment method include a method of immersing the porous carbon material precursor in an aqueous solution of an acid or an alkali; and a method of allowing the porous carbon material precursor to react with an acid or an alkali in a vapor phase. More specifically, in the case of treating with an acid, examples of the acid include fluorine compounds exhibiting acidity, such as hydrogen fluoride, hydrofluoric acid, ammonium fluoride, calcium fluoride, and sodium fluoride. In the case of using a fluorine compound, it is desirable that the amount of fluorine element is four or more times the amount of silicon element present in the silicon components contained in the porous carbon material precursor, and it is preferable that the concentration of the aqueous solution of the fluorine compound is 10% by mass or more. In a case where the silicon components (For example, silicon dioxide) contained in the porous carbon material precursor are eliminated using hydrofluoric acid, silicon dioxide reacts with hydrofluoric acid as indicated by chemical formula (A) or chemical formula (B), and is eliminated as hexafluorosilicic (F₂SiF₆) or silicon tetrafluoride (SiF₄). Thus, a porous carbon material precursor can be obtained. Thereafter, the porous carbon material intermediate may be washed and dried.

SiO₂+6HF→H₂SiF₆+2H₂O (A)

SiO₂+4HF→SiF₄+2H₂O (B)

Furthermore, in the case of treating the porous carbon material intermediate with an alkali (base), examples of the alkali include sodium hydroxide. In the case of using an aqueous solution of an alkali, the pH of the aqueous solution may be 11 or more. In a case where the silicon components (for example, silicon dioxide) contained in the porous carbon material precursor are eliminated using an aqueous solution of sodium hydroxide, as the aqueous solution of sodium hydroxide is heated, silicon dioxide reacts as indicated by Chemical Formula (C), and is eliminated as sodium silicate (Na₂SiO₃). Thus, a porous carbon material intermediate is obtained. Furthermore, in a case where sodium hydroxide is treated by allowing to react in the vapor phase, when solid sodium hydroxide is heated, sodium hydroxide reacts as indicated by Chemical Formula (C), and is eliminated as sodium silicate (Na₂SiO₃). Thus, a porous carbon material intermediate is obtained. Thereafter, the porous carbon material intermediate may be washed and dried.

SiO₂+2NaOH→Na₂SiO₃+H₂O (C)

As described above, in a porous carbon material having an inverse opal structure, the pores may have three-dimensional regularity and may be arranged macroscopically in a disposition that constitutes a crystal structure. The arrangement of pores is not particularly limited as long as the arrangement is macroscopically in a state of disposition corresponding to a crystalline structure, and an example of such a crystal structure may be a single crystal structure. Specific examples thereof include a face-centered cubic structure, a body-centered cubic structure, and a simple cubic structure; however, particularly, as described above, a face-centered cubic structure, that is, a closest packing structure, is desirable from the viewpoint of increasing the surface area of the porous carbon material. The fact that pores are arranged in a state of disposition corresponding to a crystalline structure implies a state in which pores are positioned at the positions of disposition of atoms in a crystal. As discussed above, it is preferable that the pores are arranged macroscopically in a face-centered cubic structure, and it is more preferable that the pores are arranged macroscopically in a state of disposition corresponding to the (111) plane orientation in a face-centered cubic structure (specifically, a state in which the pores are positioned at the positions of disposition of the atoms located on a (111) plane of a face-centered cubic structure).

Here, the term “macroscopically” means that a state of disposition corresponding to a crystalline structure can be seen in a region having a size exceeding a microscopic region (for example, a region having a size of 10 μm×10 μm). Furthermore, it means a case where the reflection spectrum exhibits absorption almost at a single wavelength on the surface of the porous carbon material, and the entire porous carbon material is monochromatic. That is, for example, when the porous carbon material is placed in the dark and is irradiated with white light at a glancing angle of 0°, and the wavelength of the reflected light is measured, if the reflection spectrum thus obtained exhibits unimodal absorption at a particular wavelength equivalent to the pore diameter, it can be said that the pores are arranged almost with regularity at a predetermined distance inside the material. Specifically, for example, if the porous carbon material exhibits unimodal absorption at a wavelength of 450 nm, pores having a diameter of about 280 nm are arranged almost with regularity.

The pores can be made to be continuously arranged. Also, the shape of the pores is not particularly limited, and for example, as will be described below, the shape is determined to a certain extent by the shape of the colloidal crystals used at the time of production of the porous carbon material. However, when the mechanical strength of the porous carbon material and the shape controllability of the colloidal crystals in a nanometer scale are taken into consideration, a spherical shape or an approximately spherical shape is preferred.

A porous carbon material having an inverse opal structure can be produced by, for example, polymerizing a polymerizable monomer in a state in which nanoscale colloidal crystals are immersed in a solution of the polymerizable monomer or a solution of a composition containing the polymerizable monomer, further carbonizing the polymerization product, and then removing the colloidal crystals. Meanwhile, a colloidal crystal implies that colloidal particles are aggregated and are arranged in a state of disposition corresponding to a crystalline structure, and the colloidal crystals have three-dimensional regularity. That is, the term means a state in which colloidal particles are positioned at the positions of disposition of atoms in a crystal. The pores correspond to the voids generated by the individual colloidal particles eliminated. That is, colloidal crystals function as a kind of a template. The pores may be voids closed with the carbon material as long as the pores have the three-dimensional regularity described above; however, voids that are continuously arranged are preferred in view of extending the surface area. Since the arrangement of the pores is determined by the packing arrangement of the colloidal particles in the colloidal crystals, the regularity of the arrangement of the pores described above reflects the regularity of the arrangement of the colloidal particles and the state of arrangement. In a case where the porous carbon material contains pores of different sizes, a pattern of disposition of pores having a further complicated regularity can be obtained.

Specifically, the porous carbon material having an inverse opal structure can be produced by, for example, a method for producing a porous carbon material, the method including:

(a) a step of obtaining a blend composition by immersing nanoscale colloidal crystals (collection of colloidal particles such as inorganic particles, inorganic material particles, or inorganic compound particles, which serve as a template) in a solution of a polymerizable monomer or a solution of a composition containing a polymerizable monomer;

(b) a step of polymerizing the polymerizable monomer in the blend composition, and thereby obtaining a composite of a polymeric material and the colloidal crystals (hereinafter, may be referred to as “colloidal crystal composite”);

(c) a step of carbonizing the polymeric material in the colloidal crystal composite at 800° C. to 3000° C. in an inert gas atmosphere; and

(d) a step of dissolving and removing the colloidal crystals by immersing the colloidal crystal composite that has the polymeric material carbonized therein (hereinafter, may be referred to as “carbonized colloidal crystal composite”) in a liquid capable of dissolving the colloidal crystals, and thereby obtaining a porous carbon material formed from a carbonized polymeric material.

The rate of temperature increase to reach the temperature for carbonization is not particularly limited as long as the rate is within a range of the rate of temperature increase in which the colloidal crystals are not disintegrated by local heating. Further, the porous carbon material obtainable using colloidal crystals have, in a macroscopic view, three-dimensional regularity and continuity in the arrangement of pores, as described above.

The shape of the colloidal particles that constitute the colloidal crystals is preferably a spherical shape or an approximately spherical shape. It is preferable that the colloidal particles are constructed from, for example, particles of an inorganic compound that dissolves in a fluorine compound solution of hydrofluoric acid, an alkaline solution, or an acidic solution. Specific examples of the inorganic compound include carbonates of alkaline earth metals such as calcium carbonate, barium carbonate, and magnesium carbonate; silicates of alkaline earth metals such as calcium silicate, barium silicate, and magnesium silicate; phosphates of alkaline earth metals such as calcium phosphate, barium phosphate, and magnesium phosphate; metal oxides such as silica, titanium oxide, iron oxide, cobalt oxide, zinc oxide, nickel oxide, manganese oxide, and aluminum oxide; metal hydroxides such as iron hydroxide, nickel hydroxide, aluminum hydroxide, calcium hydroxide, and chromium hydroxide; metal silicates such as zinc silicate and aluminum silicate; and metal carbonates such as zinc carbonate and basic copper carbonate. Furthermore, examples of natural products include shirasu balloon and pearlite.

The starting material of the porous carbon material having an inverse opal structure (being a solution of a polymerizable monomer or a composition containing a polymerizable monomer, and specifically, a polymer that can be converted to a porous carbon material) is not particularly limited as long as the starting material is a polymer that can be converted to a carbon material by carbonization. Specific examples thereof include a furfuryl alcohol resin, a phenol-aldehyde resin, a styrene-divinylbenzene copolymer, and a furfuryl alcohol-phenol resin. It is more preferable to use a starting material from which glassy (amorphous), non-graphitizable carbon, or easily graphitizable carbon, or graphite (graphitized carbon) is obtained as the porous carbon material.

In the step (a) of immersing colloidal crystals in a solution of a polymerizable monomer or a solution of a composition containing a polymerizable monomer, the concentration of the polymerizable monomer may be set to 0.1% by mass to 99.9% by mass, and if needed, 0.001% by mass to 50% by mass of a crosslinking agent is added thereto. Furthermore, regarding the reaction conditions such as the initiator concentration or the polymerization method, conditions appropriate for the polymerizable monomer may be selected. For example, a polymerizable monomer, a catalyst, a polymerization initiator, a crosslinking agent and the like are dissolved in a nitrogen-purged organic solvent to obtain a solution, and the colloidal crystals and this solution may be mixed. Furthermore, in the step (b) of obtaining a colloidal crystal composite, polymerization may be carried out by heating to an appropriate temperature or by irradiating light. The polymeric material can be obtained based on known solution polymerization, bulk polymerization, emulsion polymerization, reverse phase suspension polymerization and the like, such as a radical polymerization method and a polycondensation method using an acid, for example, at a polymerization temperature of 0° C. to 100° C. for a polymerization time of 10 minutes to 48 hours.

In step (a), colloidal crystals are formed from colloidal particles, and an example of the method for forming these colloidal crystals may be:

(A) a method of dropping a solution containing colloidal particles (hereinafter, referred to as “colloidal solution”) on a substrate, and distilling off the solvent included in the dropped colloidal solution. Distilling-off of the solvent may be carried out at room temperature; however, it is preferable to carry out the process by heating to a temperature equal to the boiling point of the solvent used, or to a temperature higher than the boiling point. Furthermore, a colloidal solution may be dropped onto a substrate, and then the solvent may be distilled off by heating the substrate; or a colloidal solution may be dropped onto a substrate that has been heated in advance, and then the solvent may be distilled off. When the colloidal solution is dropped, or after the solution has been dropped, the substrate may be rotated. The film thickness and area of the resulting blend composition can be controlled by repeating the operations of dropping of the colloidal solution and distilling-off of the solvent, by adjusting the concentration of the colloidal solution, by adjusting the amount of the colloidal solution to be dropped, or by appropriately combining the above-described operations. Particularly, enlargement of the surface area can be easily achieved while maintaining the three-dimensional regularity. Specifically, since a colloidal solution having a solid content concentration of 10% by mass or more can be used, a blend composition having a significant thickness can be formed on the substrate by a single dropping, and the thickness of the blend composition can be controlled by repeating dropping and distilling-off (drying). Furthermore, for example, by using a monodisperse colloidal solution, the colloidal crystals thus obtainable can be made into colloidal crystals having a single crystal structure.

Alternatively, another method for forming colloidal crystals may be:

(B) a method of suction filtering the colloidal solution to remove the solvent, and depositing the blend composition. Specifically, when the solvent is removed by suction from the colloidal solution by means of suction under reduced pressure using a suction funnel, the blend composition can be deposited on a filter paper or a filter cloth on the suction funnel. Even in this method, for example, if a monodisperse colloidal solution is used, the resulting colloidal crystals can be made to have a single crystal structure. The concentration of the colloidal solution used for the suction filtration can be appropriately selected based on the volume of the blend composition intended to obtain by a single operation. Furthermore, once all the solvent has been removed by suction, when the colloidal solution is added again and then the same operation is repeated, a blend composition having a desired volume can be obtained. Through such a method, the blend composition can have an enlarged surface area and an increased volume, while maintaining the three-dimensional regularity. There are no particular limitations on the method of suctioning the solvent, and a method of suctioning using an aspirator, a pump or the like may be used. The rate of suctioning is also not particularly limited, and for example, a state in which the degree of pressure reduction is set to about 40 mmHg, and the meniscus of the colloidal solution in the suction funnel is lowered at a constant rate, is desirable.

Alternatively, another example of the method for forming colloidal crystals may be:

(C) a method of immersing a substrate in the colloidal solution, pulling up the substrate, and evaporating the solvent. Specifically, the lower part of two sheets of smooth substrates arranged to face each other at an interval of several tens of micrometers (μm) is immersed into a relatively dilute colloidal solution having a solid content concentration of 1% by mass to 5% by mass, the colloidal solution is caused to rise between the substrates by the capillary phenomenon, and at the same time, the solvent is evaporated. Thereby, the blend composition can be precipitated between the substrates. In this method as well, a blend composition having a desired area and a desired volume can be obtained by adjusting the concentration of the colloidal solution used or performing the operation repeatedly. The speed of pulling up the substrate is not particularly limited; however, since colloidal crystals grow at the interface between the colloidal solution and air, it is preferable to pull up the substrate at a slow speed. Furthermore, the rate of evaporating the solvent is also not particularly limited; however, it is preferable to have a slow rate for the same reason. For example, when a monodisperse colloidal solution is used, the colloidal crystals thus obtainable can be made to have a single crystal structure.

Alternatively, other examples of the method for forming colloidal crystals include:

(D) a method of applying an electric field to the colloidal solution, and then removing the solvent;

(E) a method of leaving the dispersed colloidal solution to stand still, causing the colloidal particles to spontaneously sediment to deposit, and then removing the solvent; and

(F) an advection accumulation method.

The nature of the surface of the substrate used is not particularly limited; however, it is preferable to use a substrate having a smooth surface.

In step (d), when it is intended to dissolve and remove the colloidal crystals, in a case where the colloidal crystals are constructed from an inorganic compound, a solution such as an acidic solution of a fluorine compound, an alkaline solution, or an acidic solution (hereinafter, for convenience, referred to as “colloidal crystal removing solution”) can be used. For example, in a case where the colloidal crystals are formed of silica, shirasu balloon, or a silicate, it is sufficient to immerse the carbonized colloidal crystal composite in a colloidal crystal removing solution such as an aqueous solution of hydrofluoric acid; an acidic solution of ammonium fluoride, calcium fluoride or sodium fluoride; or an alkaline solution of sodium hydroxide. The colloidal crystal removing solution is preferably such that the amount of fluorine element is four or more times the amount of the silicon element present in the carbonized colloidal crystal composite, and the concentration is preferably 10% by mass or more. Furthermore, the alkaline solution is not particularly limited as long as the pH is 11 or higher. In a case where the colloidal crystals are constructed from a metal oxide or a metal hydroxide, it is sufficient to immerse the carbonized colloidal crystal composite in a colloidal crystal removing solution such as an acidic solution of hydrochloric acid or the like. The acidic solution is not particularly limited as long as the pH is 3 or lower. In some cases, the dissolution and removal of the colloidal crystals may be carried out before carbonization of the polymeric material.

Regarding the solvent used in the method for producing a composite material for electrodes of the present disclosure, generally, an aprotic polar organic compound (for example, an amide compound, a lactam compound, a urea compound, an organic sulfur compound, or a cyclic organic phosphorus compound) can be suitably used as a single solvent or as a mixed solvent. Among these aprotic polar organic compounds, examples of the amide compound include N,N-dimethylformamide, N,N-diethylformamide, N,N-dimethylacetamide, N,N-diethylacetamide, N,N-dipropylacetamide, and N,N-dimethylbenzoic acid amide. Examples of the lactam compound include N-alkylcaprolactams such as caprolactam, N-methylcaprolactam, N-ethylcaprolactam, N-isopropylcaprolactam, N-isobutylcaprolactam, N-normal-propylcaprolactam, N-normal-butylcaprolactam, and N-cyclohexylcaprolactam; N-methyl-2-pyrrolidone (NMP), N-ethyl-2-pyrrolidone, N-isopropyl-2-pyrrolidone, N-isobutyl-2-pyrrolidone, N-normal-propyl-2-pyrrolidone, N-normal-butyl-2-pyrrolidone, N-cyclohexyl-2-pyrrolidone, N-methyl-3-methyl-2-pyrrolidone, N-ethyl-3-methyl-2-pyrrolidone, N-methyl-3,4,5-trimethyl-2-pyrrolidone, N-methyl-2-piperidone, N-ethyl-2-piperidone, N-isopropyl-2-piperidone, N-methyl-6-methyl-2-piperidone, and N-methyl-3-ethyl-2-piperidone. Furthermore, examples of the urea compound include tetramethylurea, N,N′-dimethylethyleneurea, and N,N′-dimethylpropyleneurea. Furthermore, examples of the organic sulfur compound include dimethyl sulfoxide, diethyl sulfoxide, diphenylsulfone, 1-methyl-1-oxosulfolane, 1-ethyl-1-oxosulfolane, and 1-phenyl-1-oxosulfolane. Furthermore, examples of the cyclic organic phosphorus compound include 1-methyl-1-oxophospholane, 1-normal-propyl-1-oxophospholane, and 1-phenyl-1-oxophospholane. These various aprotic polar organic compounds can be respectively used as aprotic organic solvents, singly or in mixture of two or more kinds thereof, and in mixture with other solvent components. Even among the various aprotic organic solvents, preferred examples are N-alkylcaprolactams and N-alkylpyrrolidones, and particularly preferred is N-methyl-2-pyrrolidone (NMP).

According to a preferred form of the production of lithium hydrosulfide (LiSH) in a solvent, the temperature of the solvent to which lithium hydroxide is added at the time of bubbling with hydrogen sulfide gas may be, for example, 0° C. to 200° C., and preferably 90° C. to 150° C., and the bubbling time may be, for example, 0.1 hours to 10 hours. After bubbling with hydrogen sulfide gas, when the porous carbon material is added, and the entire system is heated, lithium sulfide supported on the pores present in the porous carbon material can be obtained. The heating temperature at this time may be, for example, 150° C. to 230° C., and preferably 170° C. to 230° C., as described above, and the heating time may be, for example, 0.1 hours to 1 hour. Furthermore, the mass of the porous carbon material to be added per gram of lithium hydroxide may be, for example, 0.01 grams to 3 grams, and preferably 0.1 grams to 1.5 grams.

Meanwhile, the pore volume of the porous carbon material after an electrode has been produced can be measured by the following method. That is, a secondary battery is disassembled, an electrode is taken out, and the porous carbon material is stripped off from the electrode. Then, the porous carbon material is introduced into N-methyl-2-pyrrolidone (NMP), and the mixture is stirred for 24 hours at 200° C. and then filtered. A solid phase is dried for 12 hours at 120° C. under reduced pressure. Subsequently, the solid phase is introduced into water, ultrasonic waves are applied thereto for 3 hours, and the solid phase is dried. Thus, a sample is obtained. Various analyses may be carried out using this sample.

The secondary battery of the present disclosure can be incorporated into, for example, an electronic instrument. The electronic instrument may be basically any instrument, and includes both portable type and stationary type instruments. Specific examples of the electronic instrument include mobile telephones, mobile equipment, robots, personal computers, game players, camera-integrated VTR's (video tape recorders), on-board equipment, various domestic electric appliances, and industrial appliances. The shape, configuration, structure and form of the secondary battery are basically arbitrary.

### Example 1

Example 1 relates to the composite materials for electrodes and methods for producing the composite materials related to the first to seventh aspects of the present disclosure.

Specifically, the composite material for electrodes of Example 1 contains a plant-derived porous carbon material and lithium sulfide (LiₓS, provided that 0<x≦2, and in Example 1, x=2) supported on the pores present in the porous carbon material. The pore volume according to the MP method, MP_{PC}, of the porous carbon material is 0.1 cm³/gram or more, and the pore volume according to the MP method, MP₀, of the composite material for electrodes is less than 0.1 cm³/gram (composite material for electrodes related to the first aspect of the present specification). Alternatively, the pore volume according to the MP method, MP₀, of the composite material for electrodes is less than 0.1 cm³/gram, and the pore volume according to the MP method after water washing of the composite material for electrodes, MP₁, is larger than the pore volume MP₀ (composite material for electrodes related to the second aspect of the present disclosure). Alternatively, the volume of pores measuring less than 100 nm according to the BJH method of the porous carbon material, BJH_{PC}, is 0.3 cm³/gram or more, and the volume of pores measuring less than 100 nm according to BJH method of the composite material for electrodes, BJH₀, is less than 0.3 cm³/gram (composite material for electrodes related to the third aspect of the present disclosure). Alternatively, the volume of pores measuring less than 100 nm according to the BJH method of the composite material for electrodes, BJH₀, is less than 0.3 cm³/gram, and the volume of pores measuring less than 100 nm according to the BJH method after water washing of the composite material for electrodes, BJH₁, is larger than the pore volume BJH₀ (composite material for electrodes related to the fourth aspect of the present disclosure).

Alternatively, specifically, the composite material for electrodes of Example 1 as explained in conformity with the fifth aspect of the present disclosure is:

a composite material for electrodes containing:

a porous carbon material having an inverse opal structure; and

lithium sulfide supported on the pores present in the porous carbon material,

in which the volume of pores measuring less than 100 nm according to the BJH method of the composite material for electrodes, BJH₀, is 20% or less of the volume of pores measuring less than 100 nm according to the BJH method of the porous carbon material, BJH_{PC}.

Alternatively, specifically, the composite material for electrodes of Example 1 as explained in conformity with the sixth aspect of the present disclosure includes:

a porous carbon material; and

lithium sulfide supported on the pores present in the porous carbon material,

in which the average particle size of the porous carbon material is 0.1 μm or more, preferably 0.5 μm or more, more preferably 1.0 μm or more, and is 75 μm or less, preferably 50 μm or less, and more preferably 35 μm or less.

Alternatively, specifically, the composite material for electrodes of Example 1 as explained in conformity with the seventh aspect of the present disclosure includes:

a porous carbon material; and

lithium sulfide supported on the pores present in the porous carbon material,

in which the proportion of the volume of pores measuring 100 nm or more according to the BJH method, BJH₁₀₀, is 30% or less.

Furthermore, in regard to the composite material for electrodes of Example 1, according to a form based on the third aspect and the fourth aspect of the present disclosure, the proportion of the volume of pores measuring 100 nm or more according to the BJH method of the composite material for electrodes, BJH₁₀₀, may be 30% or less, and according to a form based on the third aspect and the fourth aspect of the present disclosure including the relevant form, the value BJH₂ obtained by dividing the pore volume of the composite material for electrodes, BJH₀, by the percentage content of the porous carbon material may be larger than the pore volume according to the BJH method after water washing of the composite material for electrodes, BJH₁. In addition, according to a form based on the third aspect and the fourth aspect of the present disclosure including the preferred forms described above, the pore volume according to the MP method of the plant-derived porous carbon material, MP_{PC}, may be 0.1 cm³/gram or more, and the pore volume according to the MP method of the composite material for electrodes, MP₀, may be less than 0.1 cm³/gram. Alternatively, according to another form, the pore volume according to the MP method of the composite material for electrodes, MP₀, may be less than 0.1 cm³/gram, and the pore volume according to the MP method after water washing of the composite material for electrodes, MP₁, may be larger than the pore volume MP₀. According to a form based on the first to fourth aspects of the present disclosure including the various preferred forms described above, the average particle size of the porous carbon material may be 0.1 μm or more, preferably 0.5 μm or more, and more preferably 1.0 μm or more, and may be 75 μm or less, preferably 50 μm or less, and more preferably 35 μm or less.

Furthermore, in regard to the composite material for electrodes of Example 1, according to a form based on the fifth aspect of the present disclosure, the proportion of the volume of pores measuring 100 nm or more according to the BJH method of the composite material for electrodes, BJH₁₀₀, may be 30% or less. Furthermore, according to a form based on the fifth aspect of the present disclosure including the relevant form, or based on the seventh aspect of the present disclosure, the average particle size of the porous carbon material may be 0.1 μm or more, preferably 0.5 μm or more, and more preferably 1.0 μm or more, and may be 75 μm or less, preferably 50 μm or less, and more preferably 35 μm or less.

Furthermore, according to a form based on the fifth to seventh aspects of the present disclosure including the various preferred forms described above, the porous carbon material may use a plant-derived material as a raw material, and the pore volume according to the MP method of the porous carbon material, MPₚ, may be 0.1 cm³/gram or more, while the pore volume according to the MP method of the composite material for electrodes, MP₀, may be less than 0.1 cm³/gram.

Furthermore, in regard to the composite material for electrodes of Example 1, according to a form based on the fifth to seventh aspects of the present disclosure including the various preferred forms described above, the porous carbon material may use a plant-derived material as a raw material, and the pore volume according to the MP method of the composite material for electrodes, MP₀, may be less than 0.1 cm³/gram, while the pore volume according to the MP method after water washing of the composite material for electrodes, MP₁, may be larger than the pore volume MP₀.

Furthermore, in regard to the composite material for electrodes of Example 1, according to a form based on the fifth to seventh aspects of the present disclosure including the various preferred forms described above, the porous carbon material may use a plant-derived material as a raw material, and the volume of pores measuring less than 100 nm according to the BJH method of the plant-derived porous carbon material, BJH_{PC}, may be 0.3 cm³/gram or more, while the volume of pores measuring less than 100 nm according to the BJH method of the composite material, BJH₀, may be less than 0.3 cm³/gram. Alternatively, according to another form, the porous carbon material may use a plant-derived material as a raw material, and the volume of pores measuring less than 100 nm according to the BJH method of the composite material for electrodes, BJH₀, may be less than 0.3 cm³/gram, while the volume of pores measuring less than 100 nm according to the BJH method after water washing of the composite material for electrodes, BJH₁, may be larger than the pore volume BJH₀.

Furthermore, according to a form based on the fifth to seventh aspects of the present disclosure including the various preferred forms described above, the proportion of the volume of pores measuring 100 nm or more according to the BJH method of the composite material for electrodes, BJH₁₀₀, may be 30% or less.

Furthermore, in regard to the composite material for electrodes of Example 1, according to a form based on the fifth to seventh aspects of the present disclosure including the various preferred forms described above, the pore volume according to the BJH method after water washing of the composite material for electrodes, BJH₁, may be larger than the value BJH₂ obtained by dividing the pore volume of the composite material for electrodes, BJH₀, by the percentage content of the porous carbon material.

Furthermore, the value of the specific surface area according to a nitrogen BET method (value of specific surface area) of the porous carbon material is 100 m²/gram or more. Here, the plant-derived porous carbon material uses a plant-derived material having a percentage content of silicon of 5% by mass or more, as a raw material (Example 1A). Alternatively, in regard to a porous carbon material having an inverse opal structure, the pores have three-dimensional regularity and are arranged macroscopically in a disposition that constitutes a crystalline structure, and the pores are arranged macroscopically in the (1,1,1) plane orientation of a face-centered cubic lattice on the surface of the material (Example 1B). Furthermore, in regard to the composite material for electrodes of the Examples, the characteristics according to the first aspect and the third aspect of the present disclosure are combined, or the characteristics of the second aspect and the fourth aspect of the present disclosure are combined. In addition, these characteristics are further combined with the characteristics of the fifth aspect to the seventh aspect of the present disclosure.

In Example 1, the composite material for electrodes was produced by the method described below. That is, first, lithium hydrosulfide (LiSH) is produced in a solvent. Specifically, lithium hydroxide was added to a solvent, and hydrogen sulfide gas was bubbled into the solvent. More specifically, 4.5 grams of lithium hydroxide was added to 300 milliliters of N-methyl-2-pyrrolidone (NMP), and the entire system was heated to 90° C. In this state, hydrogen sulfide was bubbled into the solvent. As a result, lithium hydrosulfide (LiSH) was produced by a reaction between lithium hydroxide and hydrogen sulfide, and the solid in the solvent disappeared.

Subsequently, the bubbling of hydrogen sulfide gas was stopped, and 4.5 gram of a plant-derived porous carbon material was added to the solvent. In a nitrogen gas atmosphere, the entire system was heated to elevate the temperature to 180° C., and in this state, the system was stirred for 2 hours. Thereafter, the system was cooled to room temperature, and a solid phase was separated by centrifugation. The solid phase was washed two times with NMP and two times with toluene, and thus a composite material for electrodes of Example 1A-1 was obtained.

Furthermore, a composite material for electrodes of Example 1A-2 was obtained by carrying out the same operation, except that the same plant-derived porous carbon material (provided that the amount of addition was 2.25 grams) was used. Furthermore, a composite material for electrodes of Example 1A-3 was obtained by carrying out the same operation, except that the same plant-derived porous carbon material (provided that the amount of addition was 1.5 grams) was used.

A composite material for electrodes of Example 1B-1 was obtained by carrying out the same operation, except that a porous carbon material having an inverse opal structure (provided that the amount of addition was 1.5 grams) was used instead of the plant-derived porous carbon material. Furthermore, a composite material for electrodes of Example 1B-2 was obtained by carrying out the same operation, except that the same porous carbon material having an inverse opal structure (provided that the amount of addition was 2.25 grams) was used.

Here, the plant-derived porous carbon material used in Example 1A-1, Example 1A-2, and Example 1A-3 was produced by the following method. That is, a porous carbon material precursor was obtained by carbonizing (burning) chaffs, which is a plant-derived material having a percentage content of silicon (Si) of 5% by mass or more, as a raw material at 800° C. in a nitrogen gas atmosphere. Subsequently, the porous carbon material precursor thus obtained was subjected to an alkali treatment by immersing the precursor in a 20 mass % aqueous solution of sodium hydroxide overnight at 80° C., and the silicon components in the carbonized plant-derived material were eliminated. Subsequently, the resultant was washed using water and ethyl alcohol until the pH reached 7 and dried, and thereby a porous carbon material intermediate was obtained. Thereafter, the temperature of the porous carbon material intermediate was increased to 900° C. in a nitrogen gas atmosphere, and an activation treatment using steam was carried out. Subsequently, a heating treatment was carried out at a temperature higher than the temperature used for carbonization (specifically, 800° C.). More specifically, in order to perform the heating treatment, the temperature was increased up to 1400° C. at a rate of 5° C./minute in a nitrogen gas atmosphere, and then the temperature was maintained at 1400° C. for 1 hour. Subsequently, the material thus obtained was pulverized with a jet mill to 4 μm, and thereby the plant-derived porous carbon material used in Example 1A-1, Example 1A-2, and Example 1A-3 (raw material 1A) could be obtained.

Furthermore, the porous carbon material having an inverse opal structure used in Example 1B-1 to Example 1B-2 was produced by the following method.

That is, a monodisperse silica colloid-suspended aqueous solution formed from an aqueous solution having a solid content concentration of 3% by mass to 40% by mass was prepared using, as colloidal particles, monodisperse spherical silica microparticles (trade name: SEAHOSTAR KE) manufactured by Nippon Shokubai Co., Ltd. or spherical silica microparticles (trade name: SNOWTEX) manufactured by Nissan Chemical Industries, Ltd. Meanwhile, the colloid particle size was 50 nm. The monodisperse silica colloid-suspended aqueous solution was introduced into a SPC filter holder (manufactured by Sibata Scientific Technology, Ltd.) having a diameter of 30 mm and provided with a filter cloth spread thereon, and suctioning under reduced pressure was carried out using an aspirator. The degree of pressure reduction was set to about 40 mmHg. As a result, colloidal crystals formed from silica colloid layers could be obtained on the filter cloth. A polycarbonate membrane filter manufactured by Whatman plc was used as the filter cloth. After the filter cloth was detached, the colloidal crystals were sintered at 1000° C. for 2 hours in air, and thus a thin film of colloidal crystals (silica colloidal single crystals in the form of a thin film) was obtained.

Thereafter, a blend composition was obtained by immersing the thin film of colloidal crystals into a solution of a composition containing a polymerizable monomer. Specifically, the colloidal crystals in the form of a thin film were placed on a sheet made of polytetrafluoroethylene, and a solution formed from a mixture of 10.0 grams of furfuryl alcohol and 0.05 grams of oxalic acid hexahydrate (all manufactured by Wako Pure Chemical Industries, Ltd.) was dropped onto the colloidal crystals. Then, any excess solution overflowed from the colloidal crystals was lightly wiped out. Subsequently, the colloidal crystals were introduced into a desiccator, and a vacuum was drawn several times. Thus, the colloidal crystals were reliably impregnated with the solution. In this manner, a blend composition could be obtained.

Thereafter, the polymerizable monomer in the blend composition was polymerized, and thus a colloidal crystal composite was obtained as a composite of a polymeric material (polymer resin) and colloidal crystals. Specifically, polymerization was carried out for 48 hours at 80° C. in air.

Then, the polymeric material in the colloidal crystal composite was carbonized at 800° C. to 3000° C. in an inert gas atmosphere. Specifically, the colloidal crystal composite thus obtained was heated for 1 hour at 200 degrees in an argon atmosphere or a nitrogen atmosphere in a tubular furnace, and thereby removal of moisture and re-curing of the polymeric material were carried out. Subsequently, the temperature was increased at a rate of 5° C./minute in an argon atmosphere, and then the colloidal crystal composite was carbonized at a constant temperature of 800° C. to 1400° C. for 1 hour, followed by cooling. Thus, a carbonized colloidal crystal composite, which was a silica/carbon composite, was obtained.

Thereafter, the colloidal crystals were dissolved and removed by immersing the carbonized colloidal crystal composite in a liquid capable of dissolving the colloidal crystals, and thus a porous carbon material formed from a carbonized polymeric material was obtained. Specifically, the colloidal crystal composite was immersed in a 46% aqueous solution of hydrofluoric acid for 24 hours at room temperature, and thus the colloidal crystals were dissolved. Thereafter, washing with pure water and ethyl alcohol was repeated until neutrality was reached, and thus a porous carbon material having an inverse opal structure was obtained. Ina case where electric conductivity needs to be further increased, calcination at a high temperature (1400° C. to 3000° C.) in a nitrogen atmosphere may be carried out.

The porous carbon material thus obtained was classified using a sieve having a mesh size of 75 μm, and a 75-μm passing product was obtained. This porous carbon material was designated as raw material 1B.

Meanwhile, for the method for producing a porous carbon material having an inverse opal structure, for example, another method described in Japanese Patent No. 4945884 may also be employed.

The porous carbon materials obtained as described above were observed with a scanning electron microscope (SEM), and it was confirmed that the pores in the porous carbon materials have three-dimensional regularity, that is, the pores are arranged with high three-dimensional regularity, and the pores are arranged macroscopically in a disposition that constructs a crystalline structure. Furthermore, it was confirmed that the pores are arranged macroscopically in a face-centered cubic structure, and the pores are arranged macroscopically in a state of disposition corresponding to the (111) plane orientation in a face-centered cubic structure. Furthermore, the porous carbon materials were placed in the dark and were irradiated with white light at a glancing angle of 0°, and the wavelength of the reflected light was measured. As a result, the reflection spectrum thus obtained exhibited unimodal absorption at a particular wavelength corresponding to the pore diameter, and therefore, it was confirmed that the pores are arranged with high three-dimensional regularity even in the interior of the porous carbon material. Furthermore, the pores were continuously arranged, and the shape of the pores was a spherical shape or an approximately spherical shape.

A composite material for electrodes of Comparative Example 1A was obtained by carrying out the same operation, except that 1.5 grams of Ketjen black (manufactured by Lion Corp.) was used instead of the plant-derived porous carbon material. Furthermore, a composite material for electrodes of Comparative Example 1B was obtained by carrying out the same operation, except that 1.5 grams of acetylene black (manufactured by Denki Kagaku Kogyo K.K.) was used instead of the plant-derived porous carbon material.

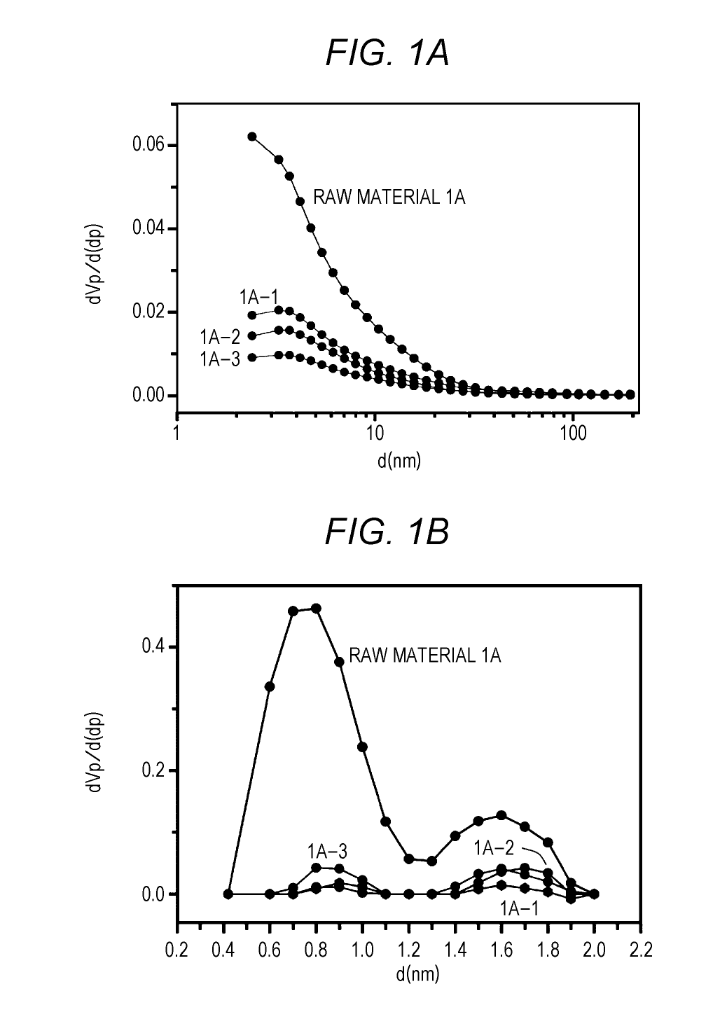

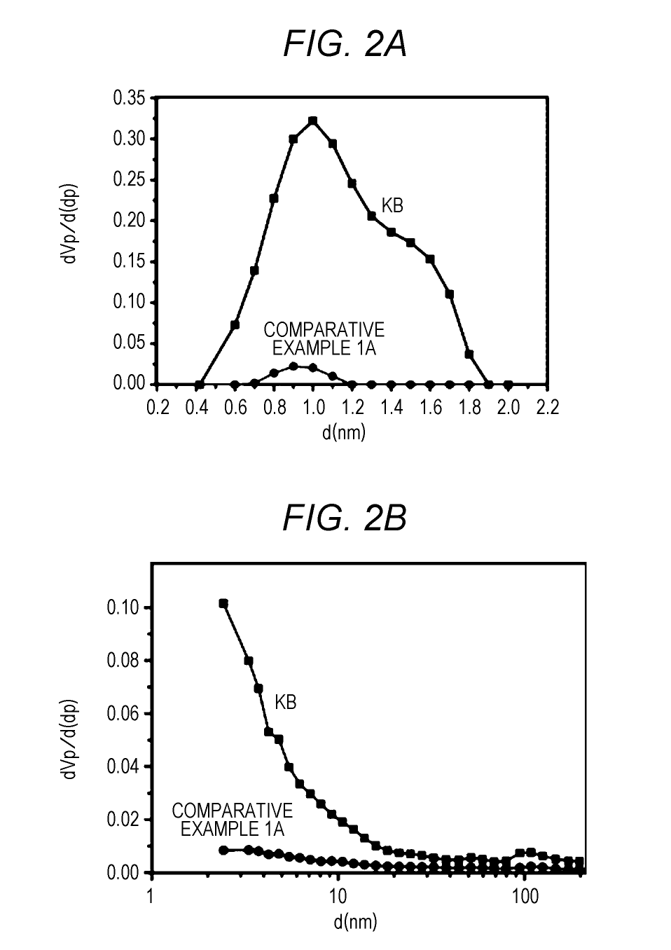

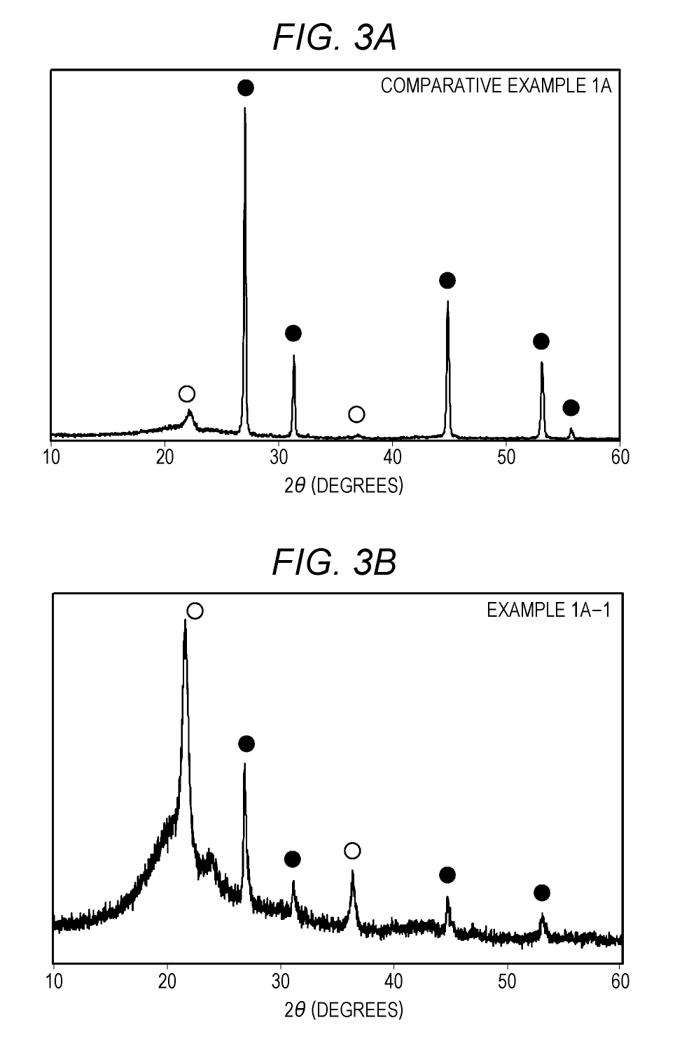

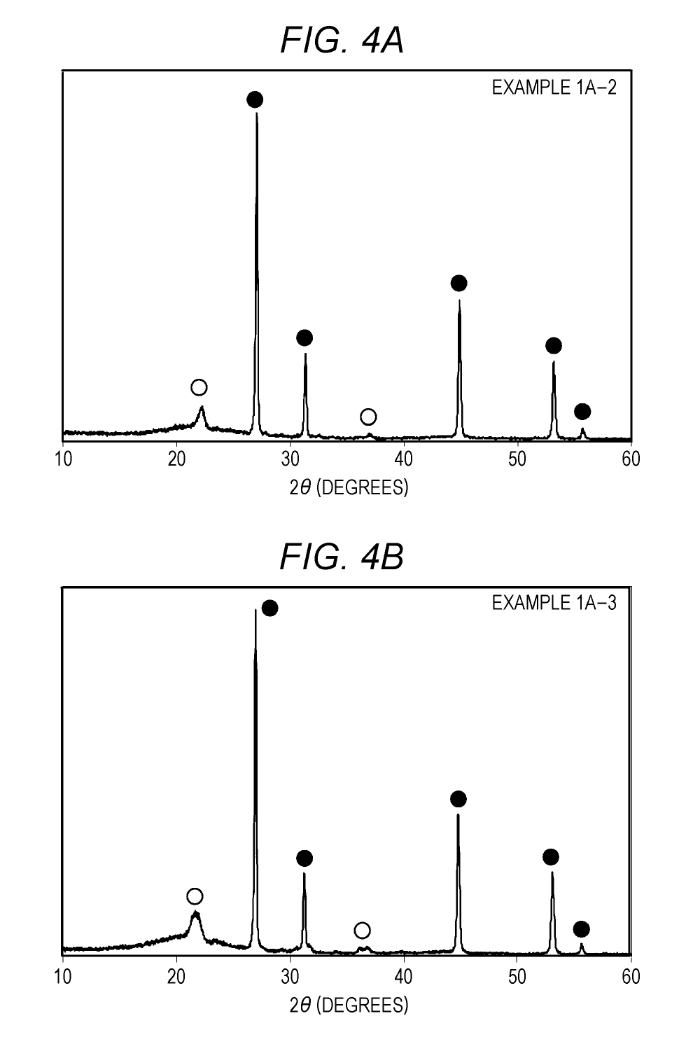

A graph of the pores distributions according to the MP method of the composite materials for electrodes of Example 1A-1, Example 1A-2, and Example 1A-3, and the plant-derived porous carbon materials is shown in FIG. 1A, and a graph of the pore distributions according to the BJH method is shown in FIG. 1B. Furthermore, a graph of the pore distributions according to the MP method of the composite material for electrodes of Comparative Example 1A and Ketjen black is shown in FIG. 2A, and a graph of the pore distributions according to the BJH method is shown in FIG. 2B. Meanwhile, the horizontal axes of FIGS. 1A, 1B, 2A, and 2B represent the pore diameter. Here, the term “raw material 1A” in FIGS. 1A and 1B represents the data of the plant-derived porous carbon material; “1A-1” represents the data for the composite material for electrodes of Example 1A-1; “1A-2” represents the data for the composite material for electrodes of Example 1A-2; “1A-3” represents the data for the composite material for electrodes of Example 1A-3; “Comparative 1A” in FIGS. 2A and 2B represents the data for the composite material for electrodes of Comparative Example 1A; and “KB” represents the data for Ketjen black. Furthermore, an X-ray diffraction analysis (XRD) of the composite materials for electrodes of Comparative Example 1A, Example 1A-1, Example 1A-2, and Example 1A-3 was carried out. The results of measuring the X-ray diffraction intensities thus obtained are presented in the graphs of FIGS. 3A, 3B, 4A, and 4B, and it was confirmed that the porous carbon materials contained lithium sulfide. Meanwhile, in order to prevent a reaction with the moisture present in air during the measurement, the measurement of the X-ray diffraction intensity was carried out in a state of being sealed with polyethylene. The conditions for the measurement of the X-ray diffraction intensity are described below. In the graphs of FIGS. 3A, 3B, 4A, and 4B, solid circles represent the X-ray diffraction intensity peaks of lithium sulfide (Li₂S), and open circles represent the X-ray diffraction intensity peaks of polyethylene. Furthermore, the values of the full width at half maximum of the X-ray diffraction intensity (corresponding to the {220} plane of Li₂S) peak of Li₂S at 2θ=44.6° are presented in the following Table 4, and the full width at half maximum of the X-ray diffraction intensity peak of the {220} plane of lithium sulfide is 0.37° or less, and more specifically, 0.3° or less.

[Conditions for Measurement of X-Ray Diffraction Intensity]

X-ray diffraction apparatus: RIGAKU RINT-2000 manufactured by Rigaku Corp.

Accelerating voltage: 40 kilovolts

Electric current: 40 milliamperes

Slit: divergence slit 1°, scattering slit 1°, receiving slit 0.3 mm

Scan speed: 5°/min

Step width: 0.02°

X-ray source: CuKα=1.5418 Angstroms

The analysis results of the composite materials for electrodes of Example 1A-1, Example 1A-2, Example 1A-3, Example 1B-1, Example 1B-2, Comparative Example 1A, and Comparative Example 1B, the plant-derived porous carbon material, the porous carbon material having an inverse opal structure, Ketjen black, and acetylene black are presented in the following Table 1-1 and Table 1-2. In Table 1-1 and Table 1-2, the terms “nitrogen BET method”, “particle size”, “MP method”, “BJH method [A] less than 50 nm”, “BJH method [B] 50 nm or more but less than 100 nm”, and “BJH method [D] 100 nm or more” mean the value of the specific surface area according to the nitrogen BET method (unit: m²/gram), the average particle size d50 (unit: μm) of the porous carbon material (porous carbon material before compositization with lithium sulfide (raw material)), the value of the pore volume according to the MP method (unit: cm³/gram), the value of the pore volume of pores having a diameter of less than 50 nm according to the BJH method (unit: cm³/gram), the value of the pore volume of pores having a diameter of 50 nm or more but less than 100 nm according to the BJH method (unit: cm³/gram), and the value of the pore volume of pores having a diameter of 100 nm or more according to the BJH method (unit: cm³/gram), respectively. The unit for the total pore volume is “cm³/gram”. Furthermore, based on the results of measuring the pore volumes of all pore diameters according to the BJH method of the composite materials for electrodes, the proportion of the pore volume for less than 50 nm, the proportion of the pore volume for 50 nm or more but less than 100 nm, and the proportion of the pore volume for 100 nm or more are summarized in Table 2, and the proportions of the pore volume for 100 nm or more according to the BJH method of the composite materials for electrodes of the Examples are 30% or less. Here, the terms “raw material 1A”, “raw material 1B”, “KB raw material”, and “AB raw material” in Table 1-1, Table 1-2 and Table 2 mean the plant-derived porous carbon material (raw material 1A), the porous carbon material having an inverse opal structure (raw material 1B), Ketjen black, and acetylene black, respectively. Meanwhile, the percentage content of silicon (Si) of the raw material 1A was less than 3% by mass. Furthermore, the values within the brackets in the columns for Example 1B-1, Example 1B-2, Comparative Example 1A, and Comparative Example 1B in relation to the pore diameter of less than 100 nm according to the BJH method and the BJH method [E] in Table 1-2, represent (BJH₀/BJH_{PC}) (unit: %).

An analysis of the composite materials for electrodes was carried out based on inductively coupled plasma (ICP) emission spectroscopy, and the percentage content of lithium in the composite materials for electrodes were determined. Furthermore, it was confirmed by an X-ray diffraction analysis (XRD) that the composite materials for electrodes did not contain any lithium compound other than lithium sulfide, and the percentage contents of lithium sulfide was determined by calculation. Then, the value BJH₂ obtained by dividing the pore volume BJH₀ by the percentage content of the porous carbon material was determined by calculation. That is,

BJH₂=BJH₀/(percentage content of porous carbon material)

Percentage content of porous carbon material=1−(percentage content of lithium sulfide).

The percentage content of lithium, the percentage content of lithium sulfide, the percentage content of the porous carbon material, and the values of the pore volumes BJH₀, BJH₂ and BJH₁ are presented in Table 3, and the pore volume BJH₁ according to the BJH method after water washing is larger than the value BJH₂ obtained by dividing the pore volume BJH₀ by the percentage content of the porous carbon material. On the other hand, in Comparative Example 1B, BJH₁ is smaller than BJH₂. However, the pore volume according to the BJH method after water washing, BJH₁, is approximately equal to the pore volume of the porous carbon material itself obtainable after lithium sulfide has been removed therefrom. In the Examples, lithium sulfide penetrates into the pores present in the porous carbon material as a result of compositization of the porous carbon material and lithium sulfide. As a result, the value BJH₂ representing the pore volume of the porous carbon material in the composite material for electrodes obtained by compositization of the porous carbon material and lithium sulfide, becomes smaller than the pore volume according to the BJH method after water washing, BJH₁ (approximately equal to the pore volume of the porous carbon material itself obtainable after lithium sulfide has been removed therefrom). On the other hand, in Comparative Example 1B, BJH₁ is smaller than BJH₂; however, this is believed to be because in Comparative Example 1B, lithium sulfide is merely adhering to the surface of acetylene black.

TABLE 1-1

| | Nitrogen BET | | Total | | Particle | MP method | |
|---|---|---|---|---|---|---|---|
| | method | | pore volume | | size [μm] | Before | After |
| | Before | After | Before | After | Raw | washing | washing |
| | washing | washing | washing | washing | material | MP₀ | MP₁ |
| Raw material 1-A | 906 | | 0.76 | | 4.0 | 0.31 | |
| (plant-derived) | | | | | | (=MP_{PC}) | |
| Example 1A-1 | 151 | 495 | 0.31 | 0.53 | | 0.01 | 0.13 |
| Example 1A-2 | 102 | 492 | 0.18 | 0.55 | | 0.00 | 0.13 |
| Example 1A-3 | 74 | 491 | 0.18 | 0.54 | | 0.00 | 0.13 |
| Raw material 1-B | 865 | | 5.12 | | 5.4 | 0.00 | |
| (inverse opal) | | | | | | | |
| Example 1B-1 | 120 | 638 | 0.54 | 5.20 | | 0.00 | 0.00 |
| Example 1B-2 | 165 | 963 | 0.77 | 4.70 | | 0.00 | 0.00 |
| KB raw material | 908 | | 1.83 | | 0.040 | 0.28 | |
| Comparative | 78 | 745 | 0.40 | 2.19 | | 0.00 | 0.23 |
| Example 1A | | | | | | | |
| AB raw material | 47 | | 0.21 | | 0.035 | 0.00 | |
| Comparative | 37 | 65 | 0.25 | 0.37 | | 0.00 | 0.00 |
| Example 1B | | | | | | | |

TABLE 1-2

| | | | BJH | | BJH | | | | | |
|---|---|---|---|---|---|---|---|---|---|---|
| | | | method [B] | | method [C] | | | | | |
| | BJH | | 50 nm or | | Less than | | BJH | | BJH | |
| | method [A] | | more but | | 100 nm | | method [D] | | method [E] | |
| | Less than | | less than | | ([A] + [B]) | | 100 nm or | | Total | |
| | 50 nm | | 100 nm | | Before | After | more | | ([C] + [D]) | |
| | Before | After | Before | After | washing | washing | Before | After | Before | After |
| | washing | washing | washing | washing | BJH₀ | BJH₁ | washing | washing | washing | washing |
| Raw material 1-A | 0.47 | | 0.02 | | 0.49 | | 0.02 | | 0.51 | |
| (plant-derived) | | | | | (=BJH_{PC}) | | | | | |
| Example 1A-1 | 0.20 | 0.38 | 0.05 | 0.02 | 0.25 | 0.40 | 0.04 | 0.02 | 0.29 | 0.42 |
| Example 1A-2 | 0.15 | 0.41 | 0.02 | 0.02 | 0.17 | 0.43 | 0.02 | 0.02 | 0.19 | 0.45 |
| Example 1A-3 | 0.13 | 0.44 | 0.03 | 0.05 | 0.16 | 0.49 | 0.05 | 0.03 | 0.21 | 0.52 |
| Raw material 1-B | 1.62 | | 2.30 | | 3.92 | | 1.13 | | 5.05 | |
| (inverse opal) | | | | | (=BJH_{PC}) | | | | | |
| Example 1B-1 | 0.28 | 2.00 | 0.20 | 2.81 | 0.48 | 4.81 | 0.07 | 0.58 | 0.55 | 5.39 |
| | | | | | (12%) | | | | (11%) | |
| Example 1B-2 | 0.33 | 2.06 | 0.35 | 2.23 | 0.68 | 4.29 | 0.08 | 0.36 | 0.76 | 4.65 |
| | | | | | (17%) | | | | (15%) | |
| KB raw material | 0.65 | | 0.21 | | 0.86 | | 0.75 | | 1.61 | |
| Comparative | 0.12 | 0.56 | 0.08 | 0.24 | 0.20 | 0.80 | 0.19 | 0.65 | 0.39 | 1.45 |
| Example 1A | | | | | (23%) | | | | (24%) | |
| AB raw material | 0.10 | | 0.03 | | 0.13 | | 0.08 | | 0.21 | |
| Comparative | 0.11 | 0.14 | 0.05 | 0.06 | 0.16 | 0.20 | 0.09 | 0.17 | 0.25 | 0.37 |
| Example 1B | | | | | (123%) | | | | (119%) | |

TABLE 2

| | | | 50 nm or | | | |
|---|---|---|---|---|---|---|
| | | | more but | | | |
| | Less than | | less than | | 100 nm or | |
| BJH | 50 nm | | 100 nm | | more | |
| measurement | Before | After | Before | After | Before | After |
| results | washing | washing | washing | washing | washing | washing |
| Raw material | 92 | | 4 | | 4 | |
| 1-A | | | | | | |
| (plant-derived) | | | | | | |
| Example 1A-1 | 69 | 90 | 17 | 5 | 14 | 5 |
| Example 1A-2 | 79 | 92 | 10 | 4 | 11 | 4 |
| Example 1A-3 | 62 | 84 | 14 | 10 | 24 | 6 |
| Raw material | 32 | | 46 | | 22 | |
| 1-B | | | | | | |
| (inverse opal) | | | | | | |
| Example 1B-1 | 51 | 37 | 36 | 52 | 13 | 11 |
| Example 1B-2 | 43 | 44 | 46 | 48 | 11 | 8 |
| KB raw | 40 | | 13 | | 47 | |
| material | | | | | | |
| Comparative | 31 | 39 | 20 | 16 | 49 | 45 |
| Example 1A | | | | | | |
| AB raw | 48 | | 14 | | 38 | |
| material | | | | | | |
| Comparative | 44 | 38 | 20 | 16 | 36 | 46 |
| Example 1B | | | | | | |

TABLE 3

| | | | Percentage | BJH measurement | | |
|---|---|---|---|---|---|---|
| | | Percentage | content of | results (less | | |
| | Percentage | content of | porous | than 100 nm) | | |
| | content of | lithium | carbon | BJH₀ | BJH₁ | BJH₂ |
| | lithium (%) | sulfide (%) | material (%) | [cm³/gr] | [cm³/gr] | [cm³/gr] |
| | Before | Before | Before | Before | After | Before |
| | washing | washing | washing | washing | washing | washing |
| Example 1A-1 | 7.9 | 26.72 | 73.28 | 0.26 | 0.40 | 0.35 |
| Example 1A-2 | 12.2 | 40.38 | 59.62 | 0.18 | 0.43 | 0.30 |
| Example 1A-3 | 15.7 | 51.97 | 48.03 | 0.14 | 0.49 | 0.29 |
| Example 1B-1 | 12.7 | 42.28 | 57.72 | 0.49 | 4.81 | 0.85 |
| Example 1B-2 | 16.1 | 54.45 | 45.55 | 0.70 | 4.29 | 1.54 |
| Comparative | 13.1 | 43.23 | 56.77 | 0.23 | 0.80 | 0.41 |
| Example 1A | | | | | | |
| Comparative | 12.5 | 41.25 | 58.75 | 0.18 | 0.20 | 0.31 |
| Example 1B | | | | | | |

TABLE 4
Full width at half maximum

| | |
|---|---|
| Example 1A-1 | 0.22° |
| Example 1A-2 | 0.22° |
| Example 1A-3 | 0.22° |
| Example 1B-1 | 0.26° |
| Example 1B-2 | 0.26° |

As can be seen from Table 1, all of the values of the specific surface area according to the nitrogen BET method, the values of the total pore volume, the values of the pore volume according to the MP method, the values of the pore volume of all pore diameters according to the BJH method, and the values of the pore volume of pores having a diameter of less than 100 nm according to the BJH method (BJH method [C]) of the composite materials for electrodes (on condition of before water washing) are lower than these values of the plant-derived porous carbon material and the porous carbon material having an inverse opal structure. This is because lithium sulfide was supported on the pores present in the porous carbon material. Furthermore, it is understood that the value of the pore volume according to the MP method of the composite material for electrodes (that is, value of the volume of micropores having a pore diameter of less than 2 nm) is 0 cm³/gram or almost 0 cm³/gram, and micropores having a pore diameter of less than 2 nm are embedded by lithium sulfide. In the composite materials for electrodes, the value of the total volume of mesopores having a pore diameter of 2 nm to 50 nm and macropores having a pore diameter of more than 50 nm but less than 100 nm is lower than the value of the porous carbon material before compositization with lithium sulfide, and it is understood that the mesopores having a pore diameter of 2 nm to 50 nm and the macropores having a pore diameter of more than 50 nm but less than 100 nm are embedded by lithium sulfide. Furthermore, the value of the specific surface area according to the nitrogen BET method, the value of the total pore volume, the value of the pore volume according to the MP method, the value of the pore volume of all pore diameters according to the BJH method, and the value of the volume of pores having a pore diameter of less than 100 nm according to the BJH method of the composite materials for electrodes of Examples (on condition of after water washing) are all higher than the values before water washing. This is due to the removal of lithium sulfide supported on the pores present in the porous carbon material, caused by water washing.

For a comparison, 3 grams of lithium sulfide was added to 100 milliliters of water, and the mixture was stirred for 1 hour. Thereafter, 1 gram of Ketjen black was added thereto, and the resulting mixture was stirred for 2 hours. Subsequently, the temperature was increased to 100° C., and water was evaporated. Thus, the material of Comparative Example 1a was obtained. When an X-ray diffraction analysis (XRD) of this Comparative Example 1a was carried out, lithium sulfide was not recognized, and only lithium hydroxide was recognized.

Furthermore, for a comparison, 3 grams of lithium sulfide and 1 gram of Ketjen black were mixed, and the mixture was ground with a mortar for 1 hour. Thereafter, the mixture was heated for 1 hour at 950° C. in a nitrogen gas atmosphere, and thus a material of Comparative Example 1b was obtained. The material of Comparative Example 1b was a white solid, and when an X-ray diffraction analysis (XRD) of Comparative Example 1b was carried out, it was confirmed that carbon had reacted and disappeared.

### Example 2

Example 2 relates to a secondary battery related to the first to fifth aspects of the present disclosure. The secondary battery of Example 2 includes an electrode produced from the composite material for electrodes of Example 1, and this electrode constitutes a positive electrode of the secondary battery. Furthermore, the secondary battery is formed from a lithium-sulfur secondary battery.

In Example 2, a positive electrode of a secondary battery was produced using the composite material for electrodes of Example 1A-2 (lithium sulfide-porous carbon composite material) and other materials, and thus a secondary battery was produced. Specifically, a slurry of the blend indicated in the following Table 5 was prepared. “KB6” represents a carbon material manufactured by Lion Corp., and “PVDF” is an abbreviation of polyvinylidene fluoride, which functions as a binder.

TABLE 5
Electrode of secondary battery of Example 2

| | mass % |
|---|---|
| Example 1A-2 | 78 |
| KB6 | 12 |
| PVDF | 10 |

More specifically, a blend (a positive electrode material and an active material for a positive electrode) having the composition indicated in Table 5 described above was mixed with NMP as a solvent and was kneaded in a mortar, and thus the mixture was prepared into a slurry form. Then, the kneaded product was applied on an aluminum foil, and the kneaded product was dried by hot air blowing at 120° C. for 3 hours. Subsequently, the kneaded product and the aluminum foil were hot pressed using a hot pressing apparatus under the conditions of a temperature of 80° C. and a pressure of 580 kgf/cm². Thus, an increase in the density of the positive electrode material was attempted, the occurrence of damage upon the contact with a liquid electrolyte was prevented, and a decrease in the resistance value was attempted. Thereafter, the pressed product was subjected to punching processing so as to obtain a sample having a diameter of 15 mm, and the sample was vacuum dried for 3 hours at 60° C. to achieve the removal of moisture and the solvent. The thickness of the portion of the positive electrode excluding the aluminum foil (positive electrode material layer) thus obtained was 10 μm to 30 μm, and the mass was 2 milligrams to 3 milligrams. Subsequently, a lithium-sulfur secondary battery formed from a 2016-type coin battery was assembled using the positive electrode obtained as described above. Specifically, a positive electrode composed of an aluminum foil and a positive electrode material layer, a liquid electrolyte, a lithium foil having a thickness of 1.0 mm as a negative electrode material, and a nickel mesh as a current collector were laminated, and thus a lithium-sulfur secondary battery formed from a 2016-type coin battery was assembled. Meanwhile, F20-MBU manufactured by Tonen General Sekiyu K.K. was used as a separator. Furthermore, a liquid electrolyte obtained by dissolving 0.5 moles of lithium bis(trifluoromethylsulfonyl)imide (LiTFSI, (CF₃SO₂)₂NLi)/0.4 moles of LiNO₃ in a mixed solvent of dimethyl ether and 1,3-dioxane (volume ratio: 1/1) was used.

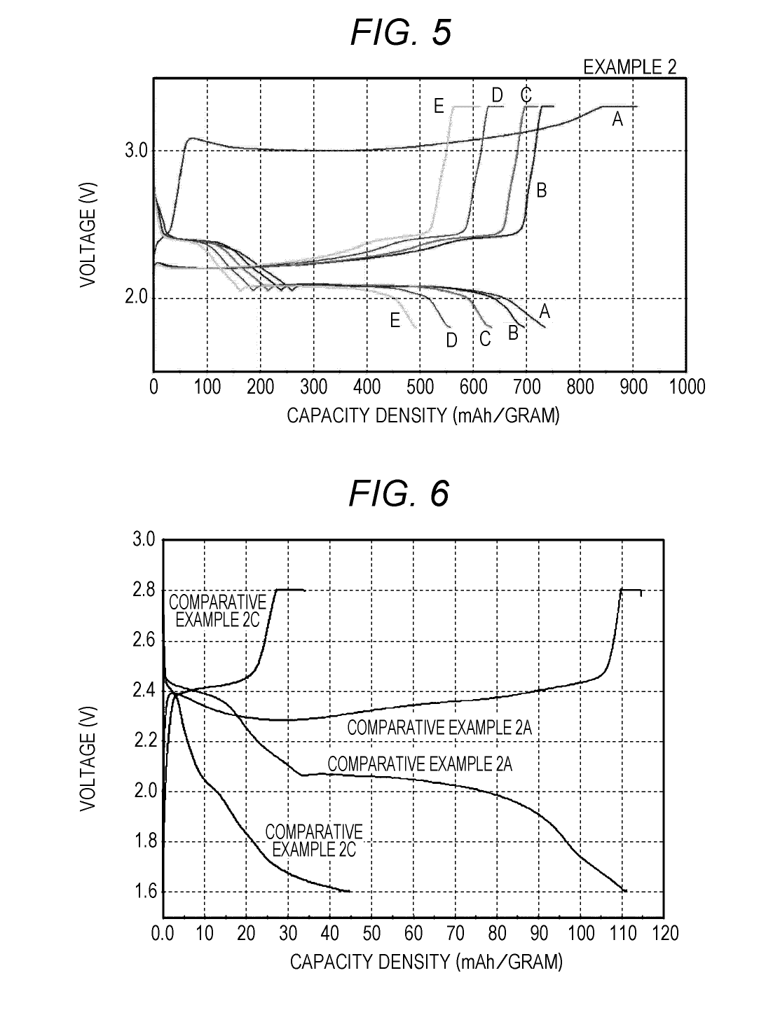

The conditions for a charge-discharge test of the lithium-sulfur secondary battery were set as indicated in the following Table 6-1. Meanwhile, the discharge conditions were set at 0.05 C. As a graph of the results of a charge-discharge test under the conditions indicated in Table 6-1 is shown in FIG. 5, it could be confirmed that the secondary battery of Example 2 maintained high capacity even if the battery was subjected to 15 cycles of charge and discharge. Meanwhile, in FIG. 5, the curves of “A”, “B”, “C”, “D” and “E” represent the first charge-discharge, the second charge-discharge, the fifth charge-discharge, the tenth charge-discharge, and the 15th charge-discharge, respectively. The horizontal axes of FIG. 5 to FIG. 12 represent the charge-discharge capacity, and the unit is “mAh/(gram of lithium sulfide)”. A graph of the results of a charge-discharge test of the secondary battery of Example 2 under the conditions indicated in Table 6-2 is presented in FIG. 8.

TABLE 6-1

| | |
|---|---|
| Current: | 0.05 C |
| Cut-off: | 1.8 volts upon discharging (on condition of constant |
| | current discharge) |
| | 3.3 volts upon charging (on condition of constant |
| | current/constant voltage charge) |

TABLE 6-2

| | |
|---|---|
| Current: | 0.05 C |
| Cut-off: | 1.5 volts upon discharging (on condition of constant |
| | current discharge) |
| | 3.3 volts upon charging (on condition of constant |
| | current/constant voltage charge) |

In Comparative Example 2A, a positive electrode of a secondary battery was produced using the composite material for electrodes of Comparative Example 1A and other materials, and a secondary battery was produced. Specifically, a slurry of the blend indicated in the following Table 7 was prepared. “PVA” is an abbreviation for polyvinyl alcohol, and functions as a binder. Furthermore, “VGCF” is a vapor phase-grown carbon fiber manufactured by Showa Denko K.K. In order to start the secondary batteries of Comparative Example 2B and Comparative Example 2C, slurries of the blends indicated in the following Table 8 and Table 9 were prepared. Then, positive electrodes each including an aluminum foil were produced by the same method as that used in Example 2, using the blends (a positive electrode material and an active material for a positive electrode) having the compositions indicated in Table 7, Table 8 and Table 9. The thickness of the portion of positive electrode thus obtained excluding the aluminum foil (positive electrode material layer) was 80 μm to 100 μm, and the mass was 8 milligrams to 12 milligrams. Subsequently, lithium-sulfur secondary batteries formed from a 2016-type coin battery were assembled in the same manner as in Example 2, using the positive electrodes obtained as described above.

TABLE 7
Electrode of secondary battery of Comparative example 2A

| | mass % |
|---|---|
| Comparative Example 1A | 87 |
| KB6 | 3 |
| PVA | 10 |

TABLE 8
Electrode of secondary battery of Comparative Example 2B

| | mass % |
|---|---|
| Comparative Example 1B | 78 |
| VGCF | 6 |
| PVDF | 10 |

TABLE 9
Electrode of secondary battery of Comparative Example 2C

| | mass % |
|---|---|
| Lithium sulfide | 60 |
| KB6 | 30 |
| PVA | 10 |

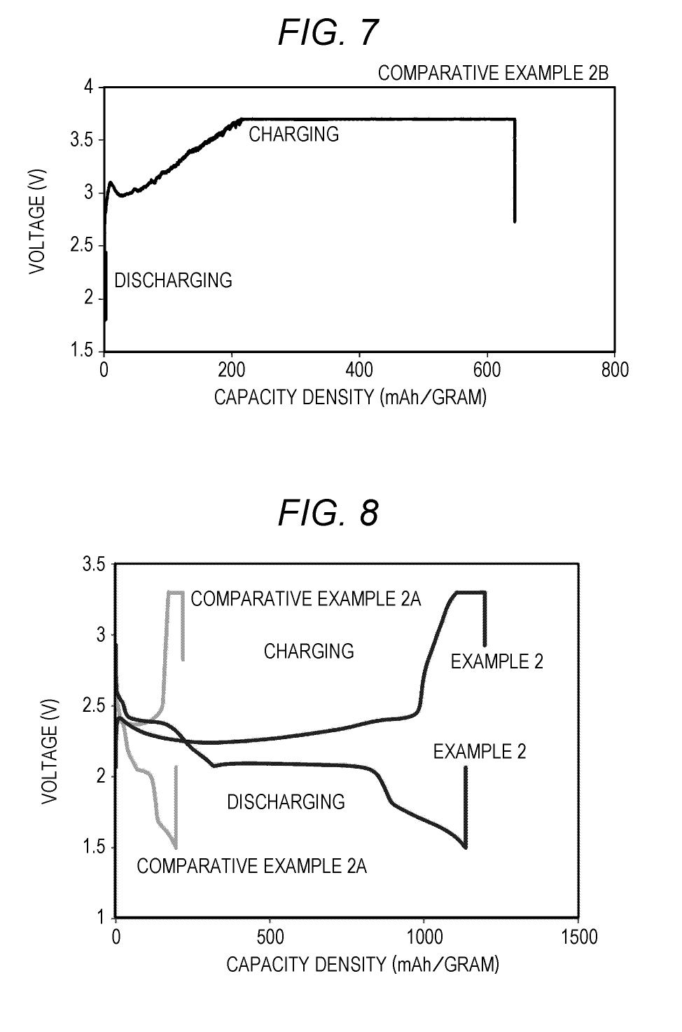

The conditions for a charge-discharge test of the lithium-sulfur secondary batteries of Comparative Example 2A and Comparative Example 2C were set as indicated in the following Table 10. Furthermore, the conditions for a charge-discharge test of the lithium-sulfur secondary battery of Comparative Example 2B were set as indicated in the following Table 11. Meanwhile, the discharge conditions were set at 0.05 C. The results of the charge-discharge test of the lithium-sulfur secondary batteries of Comparative Example 2A and Comparative Example 2C are presented in FIG. 6, and it was confirmed that the secondary batteries of Comparative Example 2A and Comparative Example 2C could not maintain high potentials for a long time, and that the capacities were also small. Furthermore, the results of the charge-discharge test of the lithium-sulfur secondary battery of Comparative Example 2B are presented in FIG. 7, and in Comparative Example 2B, discharging could not be achieved at all. In this regard, it is speculated that since lithium sulfide did not penetrate into the pores, sulfur was eluted into the liquid electrolyte. Furthermore, after two cycles, charging could not be confirmed. Furthermore, a graph of the results of a charge-discharge test of the secondary battery of Comparative Example 2A under the conditions indicated in Table 6-2 is presented in FIG. 8.

TABLE 10

| | |
|---|---|
| Current: | 0.05 C |
| Cut-off: | 1.6 volts upon discharging (on condition of constant |
| | current discharging) |
| | 2.8 volts upon charging (on condition of constant |
| | current/constant voltage charging) |

TABLE 11

| | |
|---|---|
| Current: | 0.05 C |
| Cut-off: | 1.8 volts upon discharging (on condition of constant |
| | current discharging) |
| | 3.7 volts upon charging (on condition of constant |
| | current/constant voltage charging) |

As such, in Example 2, the pore volume based on the MP method or the BJH method of the porous carbon material, which is a constituent material of the composite material for electrodes, is defined, and high electron conductivity can be imparted to lithium sulfide by the porous carbon material that is a conductive material. Thus, a composite material for electrodes containing lithium sulfide as an active material and intended for obtaining a secondary battery having excellent charge-discharge cycle characteristics can be provided.

### Example 3

Example 3 is a variation of Example 2. In Example 2, the composite material for electrodes of Example 1A-2 was used. On the other hand, in Example 3, a positive electrode for a secondary battery was produced using the composite material for electrodes of Example 1A-3 (lithium sulfide-porous carbon composite material) and other materials, and a secondary battery was further produced. Specifically, a slurry having the blend indicated in the following Table 12 was produced. Then, a lithium-sulfur secondary battery formed from a 2016-type coin battery was assembled by the same method as that used in Example 2, using a blend (a positive electrode material and an active material for a positive electrode) having the composition indicated in Table 12.

TABLE 12
Electrode of secondary battery of Example 3

| | mass % |
|---|---|
| Example 1A-3 | 78 |
| KB6 | 6 |
| VGCF | 6 |
| PVDF | 10 |

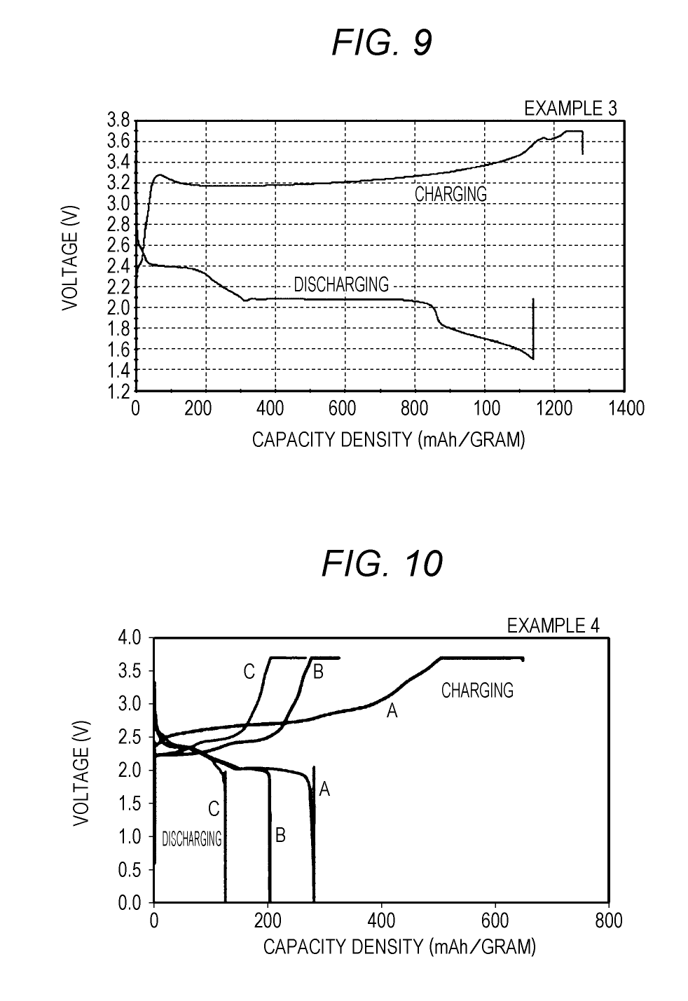

The conditions for a charge-discharge test of the lithium-sulfur secondary battery were set as described in the following Table 13. Meanwhile, the discharge conditions were set at 0.05 C. A graph of the results of the charge-discharge test is presented in FIG. 9, and the secondary battery of Example 3 could achieve 1166 mAh/(gram of lithium sulfide), which is the theoretical capacity of lithium sulfide, at the first discharge.

TABLE 13

| | |
|---|---|
| Current: | 0.05 C |
| Cut-off: | 1.5 volts upon discharging (on condition of constant |
| | current discharging) |
| | 3.7 volts upon charging (on condition of constant |
| | current/constant voltage charging) |

### Example 4

Example 4 is a variation of Example 3. In Example 3, a lithium foil having a thickness of 1.0 mm was used as the negative electrode material, and a nickel mesh was used as a current collector. On the other hand, in Example 4, the use of the negative electrode material was omitted, and a stainless steel plate was used as a current collector. Meanwhile, in Example 4 as well, a slurry of the blend indicated in Table 12 was prepared using the composite material for electrodes of Example 1A-3, and a secondary battery was produced in the same manner as in Example 3.

The conditions for a charge-discharge test of the lithium-sulfur secondary battery were set as described in the following Table 14. Meanwhile, the discharge conditions were set at 0.05 C. A graph of the results of the charge-discharge test is presented in FIG. 10, and it could be confirmed that the secondary battery of Example 4 had lithium precipitated on the stainless steel plate during discharge, and the secondary battery functioned as a secondary battery. Meanwhile, in FIG. 10, the curves of “A”, “B” and “C” represent the first charge and discharge, the second charge and discharge, and the third charge and discharge, respectively.

TABLE 14

| | |
|---|---|
| Current: | 0.05 C |
| Cut-off: | 0.0 volt upon discharging (on condition of constant |
| | current discharging) |
| | 3.7 volts upon charging (on condition of constant |
| | current/constant voltage charging) |

### Example 5

Example 5 is also a variation of Example 3. In Example 5, Si was used as the negative electrode material, and the stainless steel plate was used as a current collector. Meanwhile, also in Example 5, a slurry of the blend indicated in Table 12 was prepared using the composite material for electrodes of Example 1A-3, and a secondary battery was produced in the same manner as in Example 3. However, as a liquid electrolyte, 100 microliters of a liquid electrolyte in which a glyme and at least a portion of an alkali metal salt formed a complex, specifically a mixture of tetraglyme and lithium bis(trifluoromethylsulfonyl)imide ([Li(G4)] [TFSI]), was used, and GA-55 manufactured by Advantec MFS, Inc. was used as a separator.

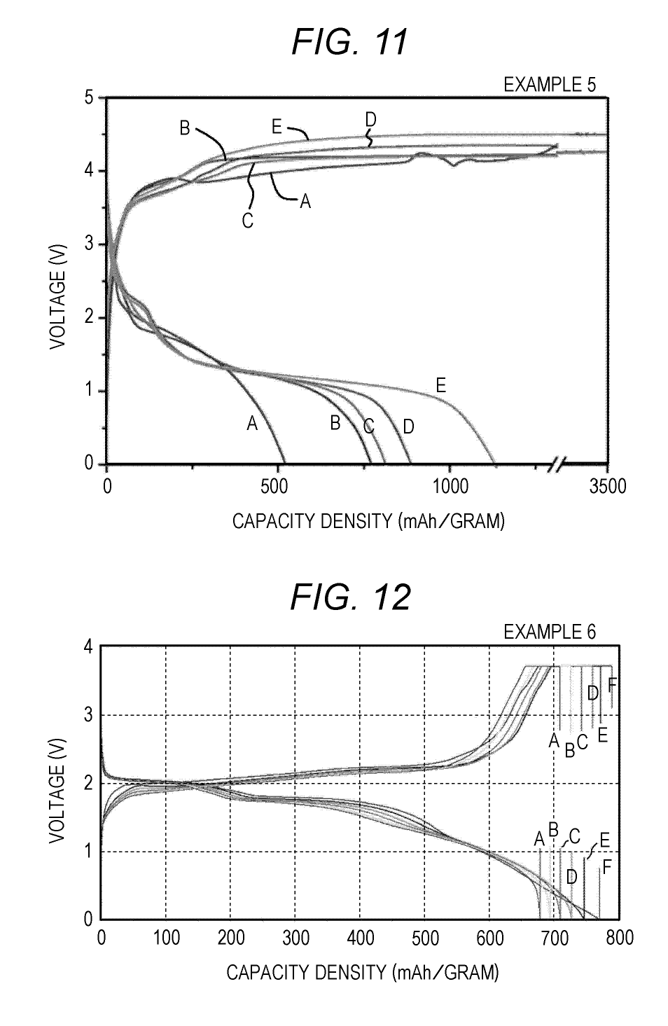

The conditions for a charge-discharge test of the lithium-sulfur secondary battery were set as described in the following Table 15. Meanwhile, the discharge conditions were set at 0.05 C. A graph of the results of the charge-discharge test is presented in FIG. 11, and it could be confirmed that the secondary battery of Example 5 functioned as a secondary battery. Meanwhile, in FIG. 11, the curves of “A”, “B”, “C”, “D” and “E” represent the first charge and discharge, the second charge and discharge, the third charge and discharge, the fourth charge and discharge, and the fifth charge and discharge, respectively.

TABLE 15

| | |
|---|---|
| Current: | 0.05 C |
| Cut-off: | 0.0 volt upon discharging (on condition of constant |
| | current discharging) |
| | 4.3 volts upon charging (on condition of constant |
| | current/constant voltage charging) |

### Example 6

Example 6 is also a variation of Example 3. In Example 6, graphite was used as the negative electrode material, and a stainless steel plate was used as a current collector. Meanwhile, also in Example 6, a slurry of the blend indicated in Table 12 was prepared using the composite material for electrodes of Example 1A-3, and a secondary battery was produced in the same manner as in Example 3. However, 100 microliters of [Li(G4)] [TFSI] was used as a liquid electrolyte in the same manner as in Example 5, and GA-55 was used as a separator.

The conditions for a charge-discharge test of the lithium-sulfur secondary battery were set as described in the above Table 14. Meanwhile, the discharge conditions were set at 0.05 C. A graph of the results of the charge-discharge test is presented in FIG. 12, and it could be confirmed that the secondary battery of Example 6 functioned as a secondary battery. Meanwhile, in FIG. 12, the curves of “A”, “B”, “C”, “D”, “E” and “F” represent the fifth charge and discharge, the tenth charge and discharge, the 15th charge and discharge, the 20th charge and discharge, the 25th charge and discharge, and the 30th charge and discharge, respectively.

Thus, the present disclosure has been explained based on preferred Examples; however, the present disclosure is not intended to be limited to these Examples, and various variations can be made. In the Examples, a compound having a composition formula of Li₂S was used as lithium sulfide; however, the composition of lithium sulfide is not intended to be limited to this. In the Examples, the plant-derived porous carbon material and the porous carbon material having an inverse opal structure have been explained; however, in addition to them, it is also possible to use activated carbon, peat coal (peat), medicinal charcoal or the like as the porous carbon material according to the present disclosure. For example, in the first to fourth aspects of the present disclosure, a porous carbon material other than the plant-derived porous carbon material can be used, and in the fifth aspect of the present disclosure, a porous carbon material other than the porous carbon material having an inverse opal structure can also be used. Furthermore, it is also possible to arbitrarily combine at least two aspects among the seven aspects, the first to seventh aspects, of the present disclosure. In the Examples, the case of using chaff s as a raw material of the porous carbon material has been explained; however, other plants may also be used as the raw material. Here, examples of the other plants include straws, reed, wakame seaweed stems, vascular plants that grow on the land, ferns, bryophytes, algae, and seaweeds. These may be used singly, or plural kinds thereof may be used in mixture. Specifically, for example, a porous carbon material intermediate can be obtained by using paddy straws (for example, product of Kagoshima; Isehikari) as a plant-derived material, which is the raw material of the porous carbon material, converting the porous carbon material to a carbonaceous material (porous carbon material precursor) by carbonizing straws as a raw material, and then subjecting the carbonaceous material to an acid treatment. Alternatively, a porous carbon material intermediate can be obtained by using reed of the Gramineae as a plant-derived material, which is the raw material of the porous carbon material, carbonizing reed of the Gramineae as a raw material to a carbonaceous material (porous carbon material precursor), and then subjecting the carbonaceous material to an acid treatment. Similar results were obtained with porous carbon materials obtained by treating with an aqueous solution of hydrofluoric acid and with an alkali (base)) such as an aqueous solution of sodium hydroxide. Meanwhile, the method for producing a porous carbon material can be carried out substantially in the same manner as in Example 1.

Alternatively, a porous carbon material intermediate can be obtained by using wakame seaweed stems (product of Sanriku of Iwate Prefecture) as a plant-derived material, which is the raw material of the porous carbon material, converting the porous carbon material intermediate to a carbonaceous material (porous carbon material precursor) by carbonizing wakame seaweed stems as a raw material, and then subjecting the carbonaceous material to an acid treatment. Specifically, first, for example, wakame seaweed stems are heated to a temperature of about 500° C., and a preliminarily carbonization treatment for carbonizing the material is carried out. Before heating, for example, the wakame seaweed stems as a raw material may also be treated with an alcohol. As a specific treatment method, a method of immersing the wakame seaweed stems in ethyl alcohol or the like may be used, and thereby the moisture contained in the raw material can be reduced, while at the same time, elements other than carbon or mineral components contained in the porous carbon material finally obtainable can be eluted out. Furthermore, generation of gases at the time of carbonization can be suppressed by this treatment with an alcohol. More specifically, wakame seaweed stems are immersed in ethyl alcohol for 48 hours. Meanwhile, it is preferable to apply an ultrasonic treatment in ethyl alcohol. Subsequently, these wakame seaweed stems are carbonized by heating for 5 hours at 500° C. in a nitrogen gas stream, and a carbonization product is obtained. By performing such a preliminary carbonization treatment, the tar component to be produced in the subsequent carbonization process can be reduced or eliminated. Thereafter, 10 grams of this carbonization product is introduced into a crucible made of alumina, and the temperature is increased to 1000° C. at a rate of temperature increase of 5° C./min in a nitrogen gas stream (10 liters/min). Then, the carbonization product is carbonized for 5 hours at 1000° C. and is converted to a carbonaceous material (porous carbon material precursor), and then the resultant is cooled to room temperature. Meanwhile, during the carbonization and cooling processes, nitrogen gas is continuously passed to flow. Subsequently, this porous carbon material precursor is subjected to an acid treatment by immersing in a 46 vol % aqueous solution of hydrofluoric acid overnight, and then the precursor is washed using water and ethyl alcohol until the pH value reached 7 and dried. Thus, a porous carbon material intermediate can be obtained.

The present disclosure may adopt the following configurations.

[A01]<<Composite Material for Electrodes: First Aspect>>

A composite material for electrodes, containing:

a plant-derived porous carbon material having a pore volume according to an MP method, MP_{PC}, of 0.1 cm³/gram or more; and

lithium sulfide supported on the pores present in the porous carbon material,

in which the pore volume according to the MP method, MP₀, is less than 0.1 cm³/gram.

[A02]<<Composite Material for Electrodes: Second Aspect>>

A composite material for electrodes, containing:

a plant-derived porous carbon material; and

lithium sulfide supported on the pores present in the porous carbon material,

in which the pore volume according to the MP method, MP₀, is less than 0.1 cm³/gram, and the pore volume according to the MP method after water washing, MP₁, is larger than the pore volume MP₀.

[A03]<<Composite Material for Electrodes: Third Aspect>>

A composite material for electrodes, including:

a plant-derived porous carbon material having a volume of pores measuring less than 100 nm according to a BJH method, BJH_{PC}, of 0.3 cm³/gram or more; and

lithium sulfide supported on the pores present in the porous carbon material,

in which the volume of pores measuring less than 100 nm according to BJH method, BJH₀, is less than 0.3 cm³/gram.

[A04]<<Composite Material for Electrodes: Fourth Aspect>>

A composite material for electrodes, containing:

a plant-derived porous carbon material; and

lithium sulfide supported on the pores present in the porous carbon material,

in which the volume of pores measuring less than 100 nm according to the BJH method, BJH₀, is less than 0.3 cm³/gram, and the volume of pores measuring less than 100 nm according to the BJH method after water washing, BJH₁, is larger than the pore volume BJH₀.

[A05] The composite material for electrodes according to [A03] or [A04], in which the proportion of the volume of pores measuring 100 nm or more according to the BJH method, BJH₁₀₀, is 30% or less.

[A06] The composite material for electrodes according to any one of [A03] to [A05], in which the pore volume according to the BJH method after water washing, BJH₁, is larger than the value BJH₂ obtained by dividing the pore volume BJH₀ by the percentage content of the porous carbon material.

[A07] The composite material for electrodes according to any one of [A03] to [A06], in which the pore volume according to the MP method of the plant-derived porous carbon material, MP_{PC}, is 0.1 cm³/gram or more, and

the pore volume according to the MP method, MP₀, is less than 0.1 cm³/gram.

[A08] The composite material for electrodes according to any one of [A03] to [A06], in which the pore volume according to the MP method, MP₀, is less than 0.1 cm³/gram, and the pore volume according to the MP method after water washing, MP₁, is larger than the pore volume MP₀.

[A09] The composite material for electrodes according to any one of [A01] to [A08], in which the average particle size of the porous carbon material is 0.1 μm or more, preferably 0.5 μm or more, and more preferably 1.0 μm or more, and is 75 μm or less, preferably 50 μm or less, and more preferably 35 μm or less.

[A10] The composite material for electrodes according to any one of [A01] to [A09], in which the porous carbon material uses a plant-derived material having a percentage content of silicon of 5% by mass or more, as a raw material.

[A11] The composite material for electrodes according to any one of [A01] to [A10], in which the full width at half maximum of the X-ray diffraction intensity peak of the {220} plane of lithium sulfide is 0.37° or less.

[A12] The composite material for electrodes according to any one of [A01] to [A11], in which the value of the specific surface area according to a nitrogen BET method of the porous carbon material is 100 m²/gram or more.

[B01]<<Composite Material for Electrodes: Fifth Aspect>>

A composite material for electrodes, containing:

a porous carbon material having an inverse opal structure; and

lithium sulfide supported on the pores present in the porous carbon material,

in which the volume of pores measuring less than 100 nm according to the BJH method of the composite material for electrodes, BJH₀, is 20% or less of the volume of pores measuring less than 100 nm according to the BJH method of the porous carbon material, BJH_{PC}.

[B02] The composite material for electrodes according to [B01], in which the proportion of the volume of pores measuring 100 nm or more according to the BJH method, is 30% or less.

[B03] The composite material for electrodes according to [B01] or [B02], in which the average particle size of the porous carbon material is 0.1 μm or more, preferably 0.5 μm or more, and more preferably 1.0 μm or more, and is 75 μm or less, preferably 50 μm or less, and more preferably 35 μm or less.

[B04]<<Composite Material for Electrodes: Sixth Aspect>>

A composite material for electrodes, containing:

a porous carbon material; and

lithium sulfide supported on the pores present in the porous carbon material,

in which the average particle size of the porous carbon material is 0.1 μm or more, preferably 0.5 μm or more, and more preferably 1.0 μm or more, and is 75 μm or less, preferably 50 μm or less, and more preferably 35 μm or less.

[B05]<<Composite Material for Electrodes: Seventh Aspect>>

A composite material for electrodes, containing:

a porous carbon material; and

lithium sulfide supported on the pores present in the porous carbon material,

in which the proportion of the volume of pores measuring 100 nm or more according to the BJH method, BJH₁₀₀, is 30% or less.

[B06] The composite material for electrodes according to [B05], in which the average particle size of the porous carbon material is 0.1 μm or more, preferably 0.5 μm or more, and more preferably 1.0 μm or more, and is 75 μm or less, preferably 50 μm or less, and more preferably 35 μm or less.

[B07] The composite material for electrodes according to any one of [B01] to [B06], in which the porous carbon material uses a plant-derived material as a raw material,

the pore volume according to the MP method of the porous carbon material, MPₚ, is 0.1 cm³/gram or more, and

the pore volume according to the MP method, MP₀, is less than 0.1 cm³/gram.

[B08] The composite material for electrodes according to any one of [B01] to [B07], in which the porous carbon material uses a plant-derived material as a raw material,

the pore volume according to the MP method, MP₀, is less than 0.1 cm³/gram, and

the pore volume according to the MP method after water washing, MP₁, is larger than the pore volume MP₀.

[B09] The composite material for electrodes according to any one of [B01] to [B08], in which the porous carbon material uses a plant-derived material as a raw material,

the volume of pores measuring less than 100 nm according to the BJH method of the plant-derived porous carbon material, BJH_{PC}, is 0.3 cm³/gram or more, and

the volume of pores measuring less than 100 nm according to the BJH method, BJH₀, is less than 0.3 cm³/gram.

[B10] The composite material for electrodes according to any one of [B01] to [B08], in which the porous carbon material uses a plant-derived material as a raw material,

the volume of pores measuring less than 100 nm according to the BJH method, BJH₀, is less than 0.3 cm³/gram, and

the volume of pores measuring less than 100 nm according to the BJH method after water washing, BJH₁, is larger than the pore volume BJH₀.

[B11] The composite material for electrodes according to any one of [B01] to [B10], in which the proportion of the volume of pores measuring 100 nm or more according to the BJH method, BJH₁₀₀, is 30% or less.

[B12] The composite material for electrodes according to any one of [B01] to [B11], in which the pore volume according to the BJH method after water washing, BJH₁, is larger than the value BJH₂ obtained by dividing the pore volume BJH₀ by the percentage content of the porous carbon material.

[B13] The composite material for electrodes according to anyone of [B01] to [B12], in which the plant-derived porous carbon material uses a plant-derived material having a percentage content of silicon of 5% by mass or more, as a raw material.

[B14] The composite material for electrodes according to any one of [B01] to [B06], in which in the porous carbon material having an inverse opal structure, the pores have three-dimensional regularity and are arranged macroscopically in a disposition that constitutes a crystalline structure.

[B15] The composite material for electrodes according to [B14], in which the pores are arranged macroscopically in the (1,1,1) plane orientation of a face-centered cubic lattice on the material surface.

[B16] The composite material for electrodes according to any one of [B01] to [B15], in which the full width at half maximum of the X-ray diffraction intensity peak of the {220} plane of lithium sulfide is 0.37° or less.

[B17] The composite material for electrodes according to any one of [B01] to [B16], in which the value of the specific surface area according to a nitrogen BET method of the porous carbon material is 100 m²/gram or more.

[C01]<<Secondary Battery: First Aspect>>

A secondary battery including an electrode produced from a composite material for electrodes, the composite material for electrodes containing:

a plant-derived porous carbon material having a pore volume according to the MP method, MP_{PC}, of 0.1 cm³/gram or more; and

lithium sulfide supported on the pores present in the porous carbon material,

in which the pore volume according to the MP method, MP₀, is less than 0.1 cm³/gram.

[C02]<<Secondary Battery: Second Aspect>>

A secondary battery including an electrode produced from a composite material for electrodes, the composite material for electrodes containing:

a plant-derived porous carbon material; and

lithium sulfide supported on the pores present in the porous carbon material,

in which the pore volume according to the MP method, MP₀, is less than 0.1 cm³/gram, and the pore volume according to the MP method after water washing, MP₁, is larger than the pore volume, MP₀.

[C03]<<Secondary Battery: Third Aspect>>

A secondary battery including an electrode produced from a composite material for electrodes, the composite material for electrodes containing:

a plant-derived porous carbon material having a volume of pores measuring less than 100 nm according to the BJH method, BJH_{PC}, of 0.3 cm³/gram or more, and

lithium sulfide supported on the pores present in the porous carbon material,

in which the volume of pores measuring less than 100 nm according to the BJH method, BJH₀, is less than 0.3 cm³/gram.

[C04]<<Secondary Battery: Fourth Aspect>>

A secondary battery including an electrode produced from a composite material for electrodes, the composite material for electrodes containing:

a plant-derived porous carbon material; and

lithium sulfide supported on the pores present in the porous carbon material,

in which the volume of pores measuring less than 100 nm according to the BJH method, BJH₀, is less than 0.3 cm³/gram, and the volume of pores measuring less than 100 nm according to the BJH method after water washing, BJH₁, is larger than the pore volume BJH₀.

[C05] The secondary battery according to [C03] or [C04], in which the proportion of the volume of pores measuring 100 nm or more according to the BJH method of the composite material for electrodes, BJH₁₀₀, is 30% or less.

[C06] The secondary battery according to any one of [C03] to [C05], in which the pore volume according to the BJH method after water washing of the composite material for electrodes, BJH₁, is larger than the value BJH₂ obtained by dividing the pore volume of the composite material, BJH₀, by the percentage content of the porous carbon material.

[C07] The secondary battery according to any one of [C03] to [C06], in which the pore volume according to the MP method of the plant-derived porous carbon material, MP_{PC}, is 0.1 cm³/gram or more, and

the pore volume according to the MP method of the composite material for electrodes, MP₀, is less than 0.1 cm³/gram.

[C08] The secondary battery according to [C03] or [C06], in which the pore volume according to the MP method of the composite material for electrodes, MP₀, is less than 0.1 cm³/gram, and the pore volume according to the MP method after water washing of the composite material for electrodes, MP₁, is larger than the pore volume MP₀.

[C09] The secondary battery according to any one of [C01] to [C08], in which the average particle size of the porous carbon material is 0.1 μm or more, preferably 0.5 μm or more, and more preferably 1.0 μm or more, and is 75 μm or less, preferably 50 μm or less, and more preferably 35 μm or less.

[C10] The secondary battery according to any one of [C01] to [C09], in which the porous carbon material uses a plant-derived material having a percentage content of silicon of 5% by mass or more, as a raw material.

[C11] The secondary battery according to any one of [C01] to [C10], in which the full width at half maximum of the X-ray diffraction intensity peak of the {220} plane of lithium sulfide is 0.37° or less.

[C12] The secondary battery according to any one of [C01] to [C11], in which the value of the specific surface area according to a nitrogen BET method of the porous carbon material is 100 m²/gram or more.

[D01]<<Secondary Battery: Fifth Aspect>>

A secondary battery including an electrode produced from a composite material for electrodes, the composite material for electrodes containing:

a porous carbon material having an inverse opal structure; and

lithium sulfide supported on the pores present in the porous carbon material,

in which the volume of pores measuring less than 100 nm according to the BJH method of the composite material for electrodes, BJH₀, is 20% or less of the volume of pores measuring less than 100 nm according to the BJH method of the porous carbon material, BJH_{PC}.

[D02] The secondary battery according to [D01], in which the proportion of the volume of pores measuring 100 nm or more according to the BJH method of the composite material for

[D03] The secondary battery according to [D01] or [D02], in which the average particle size of the porous carbon material is 0.1 μm or more, preferably 0.5 μm or more, and more preferably 1.0 μm or more, and is 75 μm or less, preferably 50 μm or less, and more preferably 35 μm or less.

[D04]<<Secondary Battery: Sixth Aspect>>

A secondary battery including an electrode produced from a composite material for electrodes, the composite material for electrodes containing:

a porous carbon material, and

lithium sulfide supported on the pores present in the porous carbon material,

in which the average particle size of the porous carbon material is 0.1 μm or more, preferably 0.5 μm or more, and more preferably 1.0 μm or more, and is 75 μm or less, preferably 50 μm or less, and more preferably 35 μm or less.

[D05]<<Composite Material for Electrodes: Seventh Aspect>>

A secondary battery including an electrode produced from a composite material for electrodes, the composite material for electrodes containing:

a porous carbon material; and

lithium sulfide supported on the pores present in the porous carbon material,

in which the proportion of the volume of pores measuring 100 nm or more according to the BJH method, BJH₁₀₀, is 30% or less.

[D06] The secondary battery according to [D05], in which the average particle size of the porous carbon material is 0.1 μm or more, preferably 0.5 μm or more, and more preferably 1.0 μm or more, and is 75 μm or less, preferably 50 μm or less, and more preferably 35 μm or less.

[D07] The secondary battery according to any one of [D01] to [D06], in which the porous carbon material uses a plant-derived material as a raw material,

the pore volume according to the MP method of the porous carbon material, MPₚ, is 0.1 cm³/gram or more, and

the pore volume according to the MP method of the composite material for electrodes, MP₀, is less than 0.1 cm³/gram.

[D08] The secondary battery according to any one of [D01] to [D07], in which the porous carbon material uses a plant-derived material as a raw material,

the pore volume according to the MP method of the composite material for electrodes, MP₀, is less than 0.1 cm³/gram, and the pore volume according to the MP method after water washing of the composite material for electrodes, MP₁, is larger than the pore volume MP₀.

[D09] The secondary battery according to any one of [D01] to [D08], in which the porous carbon material uses a plant-derived material as a raw material,

the volume of pores measuring less than 100 nm according to the BJH method of the plant-derived porous carbon material, BJH_{PC}, is 0.3 cm³/gram or more, and

the volume of pores measuring less than 100 nm according to the BJH method of the composite material for electrodes, BJH₀, is less than 0.3 cm³/gram.

[D10] The secondary battery according to any one of [D01] to [D08], in which the porous carbon material uses a plant-derived material as a raw material,

the volume of pores measuring less than 100 nm according to the BJH method of the composite material for electrodes, BJH₀, is less than 0.3 cm³/gram, and the volume of pores measuring less than 100 nm according to the BJH method after water washing of the composite material for electrodes, BJH₁, is larger than the pore volume BJH₀.

[D11] The secondary battery according to any one of [D01] to [D10], in which the proportion of the volume of pores measuring 100 nm or more according to the BJH method of the composite material for electrodes, BJH₁₀₀, is 30% or less.

[D12] The secondary battery according to any one of [D01] to [D11], in which the pore volume according to the BJH method after water washing of the composite material for electrodes, BJH₁, is larger than the value BJH₂ obtained by dividing the pore volume of the composite material for electrodes, BJH₀, by the percentage content of the porous carbon material.

[D13] The secondary battery according to any one of [D01] to [D12], in which the plant-derived porous carbon material uses a plant-derived material having a percentage content of silicon of 5% by mass or more, as a raw material.

[D14] The secondary battery according to any one of [D01] to [D06], in which in the porous carbon material having an inverse opal structure, the pores have three-dimensional regularity and are arranged macroscopically in a disposition that constitutes a crystalline structure.

[D15] The secondary battery according to [D14], in which the pores are arranged macroscopically in the (1,1,1) plane orientation of a face-centered cubic lattice on the material surface.

[D16] The secondary battery according to any one of [D01] to [D15], in which the full width at half maximum of the X-ray diffraction intensity peak of the {220} plane of lithium sulfide is 0.37° or less.

[D17] The secondary battery according to any one of [D01] to [D16], in which the value of the specific surface area according to a nitrogen BET method of the porous carbon material is 100 m²/gram or more.

[E01] The secondary battery according to any one of [C01] to [D17], in which the electrode constitutes a positive electrode.

[E02] The secondary battery according to any one of [C01] to [E01], formed from a lithium-sulfur secondary battery.

[E03] The secondary battery according to [E01] or [E02], including a liquid electrolyte in which at least portions of a glyme and an alkali metal salt form a complex.

[F01]<<Method for Producing Composite Material for Electrodes: First Aspect>>

A method for producing a composite material for electrodes, the method including producing lithium hydrosulfide in a solvent, subsequently, adding thereto a plant-derived porous carbon material having a pore volume according to an MP method, MP_{PC}, of 0.1 cm³/gram or more, heating the mixture, and thereby obtaining a composite material for electrodes containing a porous carbon material and lithium sulfide supported on the pores present in the porous carbon material,

in which the pore volume according to the MP method of the composite material for electrodes, MP₀, is less than 0.1 cm³/gram.

[F02]<<Method for Producing Composite Material for Electrodes: Second Aspect>>

A method for producing a composite material for electrodes, the method including producing lithium hydrosulfide in a solvent, subsequently adding a plant-derived porous carbon material thereto, heating the mixture, and thereby obtaining a composite material for electrodes containing a porous carbon material and lithium sulfide supported on the pores present in the porous carbon material,

in which the pore volume according to the MP method of the composite material for electrodes, MP₀, is less than 0.1 cm³/gram, and

the pore volume according to the MP method after water washing of the composite material for electrodes, MP₁, is larger than the pore volume MP₀.

[F03]<<Method for Producing Composite Material for Electrodes: Third Aspect>>

A method for producing a composite material for electrodes, the method including producing lithium hydrosulfide in a solvent, subsequently adding thereto a plant-derived porous carbon material having a volume of pores measuring less than 100 nm according to the BJH method, BJH_{PC}, of 0.3 cm³/gram or more, heating the mixture, and thereby obtaining a composite material for electrodes containing a porous carbon material and lithium sulfide supported on the pores present in the porous carbon material,

in which the volume of pores measuring less than 100 nm according to the BJH method of the composite material for electrodes, BJH₀, is less than 0.3 cm³/gram.

[F04]<<Method for Producing Composite Material for Electrodes: Fourth Aspect>>

A method for producing a composite material for electrodes, the method including producing lithium hydrosulfide in a solvent, subsequently adding a plant-derived porous carbon material thereto, heating the mixture, and thereby obtaining a composite material for electrodes containing a porous carbon material and lithium sulfide supported on the pores present in the porous carbon material,

in which the volume of pores measuring less than 100 nm according to the BJH method of the composite material for electrodes, BJH₀, is less than 0.3 cm³/gram, and

the volume of pores measuring less than 100 nm according to the BJH method after water washing of the composite material for electrodes, BJH₁, is larger than the pore volume BJH₀.

[F05] The method for producing a composite material for electrodes according to [F03] or [F04], in which the proportion of the volume of pores measuring 100 nm or more according to the BJH method of the composite material for electrodes, BJH₁₀₀, is 30% or less.

[F06] The method for producing a composite material for electrodes according to any one of [F03] to [F05], in which the pore volume according to the BJH method after water washing of the composite material for electrodes, BJH₁, is larger than the value BJH₂ obtained by dividing the pore volume of the composite material for electrodes, BJH₀, by the percentage content of the porous carbon material.

[F07] The method for producing a composite material for electrodes according to any one of [F03] to [F06], in which the pore volume according to the MP method of the plant-derived porous carbon material, MP_{PC}, is 0.1 cm³/gram or more, and

the pore volume according to the MP method of the composite material for electrodes, MP₀, is less than 0.1 cm³/gram.

[F08] The method for producing a composite material for electrodes according to any one of [F03] to [F06], in which the pore volume according to the MP method of the composite material for electrodes, MP₀, is less than 0.1 cm³/gram, and the pore volume according to the MP method after water washing of the composite material for electrodes, MP₁, is larger than the pore volume MP₀.

[F09] The method for producing a composite material for electrodes according to any one of [F01] to [F08], in which the average particle size of the porous carbon material is 0.1 μm or more, preferably 0.5 μm or more, and more preferably 1.0 μm or more, and is 75 μm or less, preferably 50 μm or less, and more preferably 35 μm or less.

[F10] The method for producing a composite material for electrodes according to any one of [F01] to [F09], in which the porous carbon material uses a plant-derived material having a percentage content of silicon of 5% by mass or more, as a raw material.

[F11] The method for producing a composite material for electrodes according to [F10], in which the porous carbon material is obtained by performing carbonization at 400° C. to 1400° C., and then performing a treatment with an acid or an alkali.

[F12] The method for producing a composite material for electrodes according to [F11], in which after a treatment with an acid or an alkali is carried out, a heating treatment is carried out at a temperature higher than the temperature used for carbonization.

[F13] The method for producing a composite material for electrodes according to any one of [F10] to [F12], in which silicon components in the plant-derived material after carbonization are eliminated by a treatment with an acid or an alkali.

[F14] The method for producing a composite material for electrodes according to any one of [F01] to [F13], in which the full width at half maximum of the X-ray diffraction intensity peak of the {220} plane of lithium sulfide is 0.37° or less.

[F15] The method for producing a composite material for electrodes according to any one of [F01] to [F14], in which the value of the specific surface area according to a nitrogen BET method of the porous carbon material is 100 m²/gram or more.

[G01]<<Method for Producing Composite Material for Electrodes: Fifth Aspect>>

A method for producing a composite material for electrodes, the method including producing lithium hydrosulfide in a solvent, subsequently adding thereto a porous carbon material having an inverse opal structure, heating the mixture, and thereby obtaining a composite material for electrodes containing a porous carbon material and lithium sulfide supported on the pores present in the porous carbon material,

in which the volume of pores measuring less than 100 nm according to the BJH method of the composite material for electrodes, BJH₀, is 20% or less of the volume of pores measuring less than 100 nm according to the BJH method of the porous carbon material, BJH_{PC}.

[G02] The method for producing a composite material for electrodes according to [G01], in which the proportion of the volume of pores measuring 100 nm or more according to the BJH method of the composite material for electrodes, BJH₁₀₀, is 30% or less.

[G03] The method for producing a composite material for electrodes according to [G01] or [G02], in which the average particle size of the porous carbon material is 0.1 μm or more, preferably 0.5 μm or more, and more preferably 1.0 μm or more, and is 75 μm or less, preferably 50 μm or less, and more preferably 35 μm or less.

[G04]<<Method for Producing a Composite Material for Electrodes: Sixth Aspect>>

A method for producing a composite material for electrodes, the method including producing lithium hydrosulfide in a solvent, subsequently adding a porous carbon material thereto, heating the mixture, and thereby obtaining a composite material for electrodes containing a porous carbon material and lithium sulfide supported on the pores present in the porous carbon material,

in which the average particle size of the porous carbon material is 0.1 μm or more, preferably 0.5 μm or more, and more preferably 1.0 μm or more, and is 75 μm or less, preferably 50 μm or less, and more preferably 35 μm or less.

[G05]<<Method for Producing Composite Material for Electrodes: Seventh Aspect>>

A method for producing a composite material for electrodes, the method including producing lithium hydrosulfide in a solvent, subsequently adding a porous carbon material thereto, heating the mixture, and thereby obtaining a composite material for electrodes containing a porous carbon material and lithium sulfide supported on the pores present in the porous carbon material,

in which the proportion of the volume of pores measuring 100 nm or more according to the BJH method of the composite material for electrodes, BJH₁₀₀, is 30% or less.

[G06] The method for producing a composite material for electrodes according to [G05], in which the average particle size of the porous carbon material is 0.1 μm or more, preferably 0.5 μm or more, and more preferably 1.0 μm or more, and is 75 μm or less, preferably 50 μm or less, and more preferably 35 μm or less.

[G07] The method for producing a composite material for electrodes according to any one of [G01] to [G06], in which the porous carbon material uses a plant-derived material as a raw material,

the pore volume according to the MP method of the porous carbon material, MP_{PC}, is 0.1 cm³/gram or more, and

the pore volume according to the MP method of the composite material for electrodes, MP₀, is less than 0.1 cm³/gram.

[G08] The method for producing a composite material for electrodes according to any one of [G01] to [G07], in which the porous carbon material uses a plant-derived material as a raw material,

the pore volume according to the MP method of the composite material for electrodes, MP₀, is less than 0.1 cm³/gram, and the pore volume according to the MP method after water washing of the composite material for electrodes, MP₁, is larger than the pore volume MP₀.

[G09] The method for producing a composite material for electrodes according to any one of [G01] to [G08], in which the porous carbon material uses a plant-derived material as a raw material,

the volume of pores measuring less than 100 nm according to the BJH method of the plant-derived porous carbon material, BJH_{PC}, is 0.3 cm³/gram or more, and

the volume of pores measuring less than 100 nm according to the BJH method of the composite material for electrodes, BJH₀, is less than 0.3 cm³/gram.

[G10] The method for producing a composite material for electrodes according to any one of [G01] to [G08], in which the porous carbon material uses a plant-derived material as a raw material,

the volume of pores measuring less than 100 nm according to the BJH method of the composite material for electrodes, BJH₀, is less than 0.3 cm³/gram, and the volume of pores measuring less than 100 nm according to the BJH method after water washing of the composite material for electrodes, BJH₁, is larger than the pore volume BJH₀.

[G11] The method for producing a composite material for electrodes according to any one of [G01] to [G10], in which the proportion of the volume of pores measuring 100 nm or more according to the BJH method of the composite material for electrodes, BJH₁₀₀, is 30% or less.

[G12] The method for producing a composite material for electrodes according to any one of [G01] to [G11], in which the pore volume according to the BJH method after water washing of the composite material for electrodes, BJH₁, is larger than the value BJH₂ obtained by dividing the pore volume of the composite material for electrodes, BJH₀, by the percentage content of the porous carbon material.

[G13] The method for producing a composite material for electrodes according to any one of [G01] to [G12], in which the plant-derived porous carbon material uses a plant-derived material having a percentage content of silicon of 5% by mass or more, as a raw material.

[G14] The method for producing a composite material for electrodes according to [G13], in which the porous carbon material is obtained by performing carbonization at 400° C. to 1400° C., and then performing a treatment with an acid or an alkali.

[G15] The method for producing a composite material for electrodes according to [G14], in which after the treatment with an acid or an alkali is carried out, a heating treatment is carried out at a temperature higher than the temperature used for carbonization.

[G16] The method for producing a composite material for electrodes according to any one of [G13] to [G15], in which after the treatment with an acid or an alkali is carried out, silicon components in the plant-derived material after carbonization are eliminated.

[G17] The method for producing a composite material for electrodes according to any one of [G01] to [G06], in which in the porous carbon material having an inverse opal structure, the pores have three-dimensional regularity and are arranged macroscopically in a disposition that constitutes a crystalline structure.

[G18] The method for producing a composite material for electrodes according to [G17], in which the pores are arranged macroscopically in the (1,1,1) plane orientation of a face-centered cubic lattice on the material surface.

[G19] The method for producing a composite material for electrodes according to any one of [G01] to [G18], in which the full width at half maximum of the X-ray diffraction intensity peak of the {220} plane of lithium sulfide is 0.37° or less.

[G20] The method for producing a composite material for electrodes according to any one of [G01] to [G19], in which the value of the specific surface area according to a nitrogen BET method of the porous carbon material is 100 m²/gram or more.

[H01] The method for producing a composite material for electrodes according to any one of [F01] to [G20], in which the production of lithiumhydrosulfide in a solvent is achieved by adding lithium hydroxide to the solvent, and bubbling hydrogen sulfide gas therein.

[H02] The method for producing a composite material for electrodes according to any one of [F01] to [H01], in which the temperature of the heating after the addition of the porous carbon material is 150° C. to 230° C.

1. A composite material for electrodes, comprising:
a plant-derived porous carbon material having a pore volume according to an MP method of 0.1 cm³/gram or more; and
lithium sulfide supported on the pores present in the porous carbon material,
wherein the pore volume according to the MP method is less than 0.1 cm³/gram.

2. A composite material for electrodes, comprising:
a plant-derived porous carbon material; and
lithium sulfide supported on the pores present in the porous carbon material,
wherein the pore volume according to an MP method, MP₀, is less than 0.1 cm³/gram, and the pore volume according to the MP method after water washing, MP₁, is larger than the pore volume MP₀.

3. A composite material for electrodes, comprising:
a plant-derived porous carbon material having a volume of pores measuring less than 100 nm according to a BJH method, of 0.3 cm³/gram or more; and
lithium sulfide supported on the pores present in the porous carbon material,
wherein the volume of pores measuring less than 100 nm according to the BJH method is less than 0.3 cm³/gram.

4. A composite material for electrodes, comprising:
a plant-derived porous carbon material; and
lithium sulfide supported on the pores present in the porous carbon material,
wherein the volume of pores measuring less than 100 nm according to a BJH method, BJH₀, is less than 0.3 cm³/gram, and the volume of pores measuring less than 100 nm according to the BJH method after water washing, BJH₁, is larger than the pore volume BJH₀.

5. A composite material for electrodes, comprising:
a porous carbon material having an inverse opal structure and
lithium sulfide supported on the pores present in the porous carbon material,
wherein the volume of pores measuring less than 100 nm according to a BJH method of the composite material for electrodes is 20% or less of the volume of pores measuring less than 100 nm according to the BJH method of the porous carbon material.

6. A composite material for electrodes, comprising:
a porous carbon material; and
lithium sulfide supported on the pores present in the porous carbon material,
wherein the average particle size of the porous carbon material is from 0.1 μm to 75 μm.

7. A composite material for electrodes, comprising:
a porous carbon material; and
lithium sulfide supported on the pores present in the porous carbon material,
wherein the proportion of the volume of pores measuring 100 nm or more according to a BJH method is 30% or less.

8. A secondary battery comprising an electrode produced from a composite material for electrodes,
the composite material for electrodes containing:
a plant-derived porous carbon material having a pore volume according to an MP method, of 0.1 cm³/gram or more; and
lithium sulfide supported on the pores present in the porous carbon material,
wherein the pore volume according to the MP method is less than 0.1 cm³/gram.

9. A secondary battery comprising an electrode produced from a composite material for electrodes,
the composite material for electrodes containing:
a plant-derived porous carbon material; and
lithium sulfide supported on the pores present in the porous carbon material,
wherein the pore volume according to an MP method, MP₀, is less than 0.1 cm³/gram, and the pore volume according to the MP method after water washing, MP₁, is larger than the pore volume MP₀.

10. A secondary battery comprising an electrode produced from a composite material for electrodes,
the composite material for electrodes containing:
a plant-derived porous carbon material having a volume of pores measuring less than 100 nm according to a BJH method, of 0.3 cm³/gram or more; and
lithium sulfide supported on the pores present in the porous carbon material,
wherein the volume of pores measuring less than 100 nm according to the BJH method is less than 0.3 cm³/gram.

11. A secondary battery comprising an electrode produced from a composite material for electrodes,
the composite material for electrodes containing:
a plant-derived porous carbon material; and
lithium sulfide supported on the pores present in the porous carbon material,
wherein the volume of pores measuring less than 100 nm according to the BJH method, BJH₀, is less than 0.3 cm³/gram, and the volume of pores measuring less than 100 nm according to the BJH method after water washing, BJH₁, is larger than the pore volume BJH₀.

12. A secondary battery comprising an electrode produced from a composite material for electrodes,
the composite material for electrodes containing:
a porous carbon material having an inverse opal structure; and
lithium sulfide supported on the pores present in the porous carbon material,
wherein the volume of pores measuring less than 100 nm according to a BJH method of the composite material for electrodes is 20% or less of the volume of pores measuring less than 100 nm according to the BJH method of the porous carbon material.

13. A secondary battery comprising:
a porous carbon material; and
lithium sulfide supported on the pores present in the porous carbon material,
wherein the average particle size of the porous carbon material is from 0.1 μm to 75 μm.

14. A secondary battery comprising an electrode produced from a composite material for electrodes,
the composite material for electrodes containing:
a porous carbon material; and
lithium sulfide supported on the pores present in the porous carbon material,
wherein the proportion of the volume of pores measuring 100 nm or more according to a BJH method is 30% or less.

15. A method for producing a composite material for electrodes, the method comprising:
producing lithium hydrosulfide in a solvent, subsequently adding thereto a plant-derived porous carbon material having a pore volume according to an MP method of 0.1 cm³/gram or more, heating the mixture, and thereby obtaining a composite material for electrodes containing a porous carbon material and lithium sulfide supported on the pores present in the porous carbon material,
wherein the pore volume according to the MP method of the composite material for electrodes is less than 0.1 cm³/gram.

16. A method for producing a composite material for electrodes, the method comprising:
producing lithium hydrosulfide in a solvent, subsequently adding a plant-derived porous carbon material thereto, heating the mixture, and thereby obtaining a composite material for electrodes containing a porous carbon material and lithium sulfide supported on the pores present in the porous carbon material,
wherein the pore volume according to an MP method of the composite material for electrodes, MP₀, is less than 0.1 cm³/gram, and
the pore volume according to the MP method after water washing of the composite material for electrodes, MP₁, is larger than the pore volume MP₀.

17. A method for producing a composite material for electrodes, the method comprising:
producing lithium hydrosulfide in a solvent, subsequently adding thereto a plant-derived porous carbon material having a volume of pores measuring less than 100 nm according to a BJH method of 0.3 cm³/gram or more, heating the mixture, and thereby obtaining a composite material for electrodes containing a porous carbon material and lithium sulfide supported on the pores present in the porous carbon material,
wherein the volume of pores measuring less than 100 nm according to the BJH method of the composite material for electrodes is less than 0.3 cm³/gram.

18. A method for producing a composite material for electrodes, the method comprising:
producing lithium hydrosulfide in a solvent, subsequently adding a plant-derived porous carbon material thereto, heating the mixture, and thereby obtaining a composite material for electrodes containing a porous carbon material and lithium sulfide supported on the pores present in the porous carbon material,
wherein the volume of pores measuring less than 100 nm according to a BJH method of the composite material for electrodes, BJH₀, is less than 0.3 cm³/gram, and
the volume of pores measuring less than 100 nm according to the BJH method after water washing of the composite material for electrodes, BJH₁, is larger than the pore volume BJH₀.

19. A method for producing a composite material for electrodes, the method comprising:
producing lithium hydrosulfide in a solvent, subsequently adding a porous carbon material having an inverse opal structure thereto, heating the mixture, and thereby obtaining a composite material for electrodes containing a porous carbon material and lithium sulfide supported on the pores present in the porous carbon material,
wherein the volume of pores measuring less than 100 nm according to a BJH method of the composite material for electrodes is 20% or less of the volume of pores measuring less than 100 nm according to the BJH method of the porous carbon material.

20. A method for producing a composite material for electrodes, the method comprising:
producing lithium hydrosulfide in a solvent, subsequently adding a porous carbon material thereto, heating the mixture, and thereby obtaining a composite material for electrodes containing a porous carbon material and lithium sulfide supported on the pores present in the porous carbon material,
wherein the average particle size of the porous carbon material is from 0.1 μm to 75 μm.

21. A method for producing a composite material for electrodes, the method comprising:
producing lithium hydrosulfide in a solvent, subsequently adding a porous carbon material thereto, heating the mixture, and thereby obtaining a composite material for electrodes containing a porous carbon material and lithium sulfide supported on the pores present in the porous carbon material,
wherein the proportion of the volume of pores measuring 100 nm or more according to a BJH method of the composite material for electrodes is 30% or less.
